SEQUENCE LISTING (6 sequences)

SEQ ID NO: 1 - protein, 19 aa, Artificial Sequence
  test peptide
FSGVAMPGAEDDVVGSGSK

SEQ ID NO: 2 - protein, 20 aa, Artificial Sequence
  test peptide
AFSGVAMPGAEDDVVGSGSK

SEQ ID NO: 3 - protein, 21 aa, Artificial Sequence
  test peptide
AEFSGVAMPGAEDDVVGSGSK

SEQ ID NO: 4 - protein, 22 aa, Artificial Sequence
  test peptide
AEAFSGVAMPGAEDDVVGSGSK

SEQ ID NO: 5 - protein, 23 aa, Artificial Sequence
  test peptide
AESAFSGVAMPGAEDDVVGSGSK

SEQ ID NO: 6 - protein, 28 aa, Artificial Sequence
  test peptide
AESAESAESFSGVAMPGAEDDVVGSGSK

(19) United States
(12) Patent Application Publication
(10) Pub. No.: US 2022/0371010 A1
(43) Pub. Date: Nov. 24, 2022

(54) CARTRIDGE SEALING MECHANISM

(71) Applicant: ENCODIA, INC., SAN DIEGO, CA (US)

(72) Inventors: Timothy Scott BURCHAM, San Diego, CA (US); Grant F. WARDEN, San Diego, CA (US)

(73) Assignee: ENCODIA, INC., SAN DIEGO, CA (US)

(21) Appl. No.: 17/745,490

(22) Filed: May 16, 2022

Related U.S. Application Data
(60) Provisional application No. 63/190,649, filed on May 19, 2021.

(51) Int. Cl. B01L 3/00

(52) U.S. Cl. CPC B01L 3/50273; B01L 3/502738; B01L 2400/0481; B01L 2200/10; B01L 2300/087; B01L 2200/0689

(57) ABSTRACT

The present disclosure relates to a mechanism for fluidic sealing of a reaction cartridge in a reaction system using a single linear actuator. A single motion provided by the linear actuator is used to establish leak-resistant fluid communication between the reaction cartridge and two independent fluidic channels. The dual-sealing assembly described herein enables the use of fewer parts and a simpler control unit. The use of fewer parts and simpler control system allow for a very compact sealing mechanism and could also increase reliability, will be easier to manufacture as it will require less manufacturing testing and calibration, and is more tolerant of variance in the part being sealed (the reaction cartridge). In some embodiments, the reaction cartridge comprises a solid support matrix and a reaction reagent attached to the solid support matrix, and the reaction system is used for treating macromolecules, such as polypeptides, for sequencing and/or analysis.

### CROSS-REFERENCE TO RELATED APPLICATIONS

The present application claims priority to U.S. provisional patent application No. 63/190,649, filed on May 19, 2021, the disclosure and content of which are incorporated herein by reference in its entirety for all purposes.

### SEQUENCE LISTING ON ASCII TEXT

This patent or application file contains a Sequence Listing submitted in computer readable ASCII text format (file name: 4614-2003000_SeqList_ST25.txt, date recorded: May 5, 2022, size: 1,921 bytes). The content of the Sequence Listing file is incorporated herein by reference in its entirety.

### TECHNICAL FIELD

The present invention relates to a chemical reaction cartridge and cartridge positioning system inside a laboratory instrument, and a method of performing a chemical reaction using the disclosed reaction cartridge.

### BACKGROUND

There are multiple examples of complex instrumentation that are designed to operate using a fluidic sample processing cartridge. One challenge in the area of biomedical research and clinical diagnostics is to provide a simple, reliable, error-proof and cost-effective system for correctly placing a reaction cartridge inside an instrument and establishing proper fluid communications between parts of the instrument and the cartridge.

Versions of systems including sample cartridges and systems for fluidic sample analysis and establishing fluid communications are described in, for example, U.S. Pat. Nos. 9,498,778; 10,208,332; 7,603,943; 10,866,218; 9,027,929; 9,011,801; 8,431,340; U.S. Patent applications 2014/0102561; 2013/0115607. The present invention provides improved methods and systems suitable for handling complex macromolecule analysis reactions inside a sample cartridge. The invention is illustrated by the description, examples and figures below.

### BRIEF SUMMARY

The present teachings include a mechanism for fluidic sealing of a reaction cartridge using a single actuator. In accordance with one aspect of the invention, a reaction system is provided comprising: (a) a reaction cartridge comprising a fluidic input and a fluidic output; (b) a fluid introduction channel configured to provide a fluid to the fluidic input; (c) a first sealing element that comprises the fluid introduction channel and is configured to establish a first seal between the fluidic input and the fluid introduction channel; (d) a fluid receiving channel configured to receive the fluid from the fluidic output; (e) a second sealing element that comprises the fluid receiving channel and is configured to establish a second seal between the fluidic output and the fluid receiving channel; and (f) a transport carriage configured to move the first sealing element and the second sealing element relative to the reaction cartridge such that to establish the first seal and the second seal, wherein the movement of the first sealing element and the second sealing element is achieved by using a single actuator.

In accordance with a further aspect, a method of reacting a first reagent and a second reagent in a reaction cartridge is provided, the method comprising: (a) placing the reaction cartridge in a reaction system between a first sealing element and a second sealing element of the reaction system, wherein the reaction cartridge comprises a fluidic input and a fluidic output, and further comprises within an interior chamber the first reagent attached to a solid support matrix; and wherein the reaction system further comprises: (i) a fluid introduction channel located within the first sealing element and configured to provide a fluid to the fluidic input; (ii) a fluid receiving channel located within the second sealing element and configured to receive the fluid from the fluidic output; and (iii) a transport carriage configured to move the first sealing element and the second sealing element relative to the reaction cartridge so that to establish a first seal between the fluidic input and the fluid introduction channel, and to establish a second seal between the fluidic output and the fluid receiving channel, wherein the movement is achieved by using a single actuator; (b) activating the single actuator so that to establish the first seal and the second seal; and (c) introducing the second reagent to the reaction cartridge via the fluidic input by pumping a fluid comprising the second reagent, thereby reacting the first reagent and the second reagent.

### BRIEF DESCRIPTION OF THE DRAWINGS

The patent or application contains at least one drawing executed in color. Copies of this patent or patent application publication with color drawing(s) will be provided by the Office upon request and payment of the necessary fee.

Non-limiting embodiments of the present invention will be described by way of example with reference to the accompanying figures, which are schematic and are not intended to be drawn to scale. For purposes of illustration, not every component is labeled in every figure, nor is every component of each embodiment of the invention shown where illustration is not necessary to allow those of ordinary skill in the art to understand the invention.

FIG. 1A and FIG. 1B show an exemplary reaction system 50, according to various embodiments of the invention. FIG. 1A shows an open state of the exemplary reaction system 50, and FIG. 1B shows a partially closed state of the exemplary reaction system 50, where fluid introduction channel 8 starts engaging with the fluidic input 4 of the reaction cartridge 1.

FIG. 2 show an exemplary reaction cartridge 1, having cap 13, two sealing elements (O-rings), and filter means 24.

FIG. 3A and FIG. 3B provide additional views of the exemplary reaction system 50 without the reaction cartridge 1. FIG. 3A shows an open state of the exemplary reaction system without the reaction cartridge (the sealing elements are separated apart). FIG. 3B shows a closed state of the exemplary reaction system without the reaction cartridge (the sealing elements came together), according to various embodiments of the invention.

FIG. 4A and FIG. 4B show another exemplary embodiment of reaction cartridge 1, which has cap 13 having an extra sealing means (O-ring) and two different filter means 24. FIG. 4A shows front view of the reaction cartridge 1, as well as corresponding A-A cross section. FIG. 4B shows isometric projection of the reaction cartridge 1 in the assembled and dissembled states.

FIG. 5 shows an exemplary variant of the reaction cartridge comprising an interior chamber with a solid support matrix, an immobilized reagent, and a filter means.

FIG. 6A-FIG. 6C illustrate an exemplary process of establishing first and second seals in the reaction system.

FIG. 7 shows an exemplary process performed inside the reaction cartridge.

FIG. 8 shows a diagram representing exemplary interactions of control unit with other elements of the reaction system.

FIG. 9 shows results of exemplary assessment of efficiency of cartridge sealing using deliveries of air and detecting pressure buildup using the pressure sensor.

FIG. 10 shows results of exemplary reactions performed in the cartridge in an automated manner (“Loader”) in comparison to the same reactions performed manually (“Control”).

### DETAILED DESCRIPTION OF THE INVENTION

Existing technologies for analyzing proteins or peptides are limited in several ways. Molecular recognition and characterization of a protein or peptide macromolecule is typically performed using an immunoassay such as ELISA, multiplex ELISA and others. Binding agent agnostic approaches such as direct protein characterization via peptide sequencing (e.g., Edman degradation or Mass Spectroscopy) provide alternative approaches. However, neither of these approaches is very parallel or high-throughput.

Accordingly, a need exists for an automated instrument and related methods for treating and preparing samples to achieve proteomics technology that is highly-parallelized, accurate, sensitive, and high-throughput. The provided instrument, parts of the instrument and related methods addresses concerns associated with manual approaches to preparing and treating samples for macromolecule analysis assay. In particular, significant advantages can be realized by automating the various process steps of a macromolecule analysis assay, including reducing the risk of user-error, contamination, and spillage, increasing accuracy and control across treatment of samples, while increasing through-put volume. In some cases, the automation of the assay (including settings, steps, reactions, conditions, etc.) can exhibit flexibility and allow changes to the process to be made. Automating the steps of a macromolecule analysis assay will also reduce the amount of training required for practitioners and eliminate sources of physical injury attributable to high-volume manual applications.

Numerous specific details are set forth in the following description in order to provide a thorough understanding of the present disclosure. These details are provided for the purpose of example and the claimed subject matter may be practiced according to the claims without some or all of these specific details. It is to be understood that other embodiments can be used and structural changes can be made without departing from the scope of the claimed subject matter. It should be understood that the various features and functionality described in one or more of the individual embodiments are not limited in their applicability to the particular embodiment with which they are described. They instead can, be applied, alone or in some combination, to one or more of the other embodiments of the disclosure, whether or not such embodiments are described, and whether or not such features are presented as being a part of a described embodiment. For the purpose of clarity, technical material that is known in the technical fields related to the claimed subject matter has not been described in detail so that the claimed subject matter is not unnecessarily obscured.

All patent publications referred to in this application are incorporated by reference in their entireties for all purposes. Citation of the publications or documents is not intended as an admission that any of them is pertinent prior art, nor does it constitute any admission as to the contents or date of these publications or documents.

Unless defined otherwise, all technical and scientific terms used herein have the same meaning as is commonly understood by one of ordinary skill in the art to which the present disclosure belongs. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, the singular forms “a,” “an” and “the” include plural referents unless the context clearly dictates otherwise. Thus, for example, reference to “a peptide” includes one or more peptides, or mixtures of peptides. Also, and unless specifically stated or obvious from context, as used herein, the term “or” is understood to be inclusive and covers both “or” and “and”.

The term “about” as used herein refers to the usual error range for the respective value readily known to the skilled person in this technical field. Reference to “about” a value or parameter herein includes (and describes) embodiments that are directed to that value or parameter per se. For example, description referring to “about X” includes description of “X.

As used herein, the term “sample” refers to anything which may contain an analyte for which an analyte assay is desired. As used herein, a “sample” can be a solution, a suspension, liquid, powder, a paste, aqueous, non-aqueous or any combination thereof. In some embodiments, the sample is a biological sample. A biological sample of the present disclosure encompasses a sample in the form of a solution, a suspension, a liquid, a powder, a paste, an aqueous sample, or a non-aqueous sample. As used herein, a “biological sample” includes any sample obtained from a living or viral (or prion) source or other source of macromolecules and biomolecules, and includes any cell type or tissue of a subject from which nucleic acid, protein and/or other macromolecule can be obtained. The biological sample can be a sample obtained directly from a biological source or a sample that is processed. For example, isolated nucleic acids that are amplified constitute a biological sample. Biological samples include, but are not limited to, body fluids, such as blood, plasma, serum, cerebrospinal fluid, synovial fluid, urine and sweat, tissue and organ samples from animals and plants and processed samples derived therefrom. In some embodiments, the sample can be derived from a tissue or a body fluid, for example, a connective, epithelium, muscle or nerve tissue; a tissue selected from the group consisting of brain, lung, liver, spleen, bone marrow, thymus, heart, lymph, blood, bone, cartilage, pancreas, kidney, gall bladder, stomach, intestine, testis, ovary, uterus, rectum, nervous system, gland, and internal blood vessels; or a body fluid selected from the group consisting of blood, urine, saliva, bone marrow, sperm, an ascitic fluid, and subfractions thereof, e.g., serum or plasma.

The terms “level” or “levels” are used to refer to the presence and/or amount of a target, e.g., a substance or an organism that is part of the etiology of a disease or disorder, and can be determined qualitatively or quantitatively. A “qualitative” change in the target level refers to the appearance or disappearance of a target that is not detectable or is present in samples obtained from normal controls. A “quantitative” change in the levels of one or more targets refers to a measurable increase or decrease in the target levels when compared to a healthy control.

As used herein, the term “macromolecule” encompasses large molecules composed of smaller subunits. Examples of macromolecules include, but are not limited to peptides, polypeptides, proteins, nucleic acids, carbohydrates, lipids, macrocycles, or a combination or complex thereof. A macromolecule also includes a chimeric macromolecule composed of a combination of two or more types of macromolecules, covalently linked together (e.g., a peptide linked to a nucleic acid). A macromolecule may also include a “macromolecule assembly”, which is composed of non-covalent complexes of two or more macromolecules. A macromolecule assembly may be composed of the same type of macromolecule (e.g., protein-protein) or of two or more different types of macromolecules (e.g., protein-DNA).

As used herein, the term “polypeptide” encompasses peptides and proteins, and refers to a molecule comprising a chain of two or more amino acids joined by peptide bonds. In some embodiments, a polypeptide comprises 2 to 50 amino acids, e.g., having more than 20-30 amino acids. In some embodiments, a peptide does not comprise a secondary, tertiary, or higher structure. In some embodiments, the polypeptide is a protein. In some embodiments, a protein comprises 30 or more amino acids, e.g. having more than 50 amino acids. In some embodiments, in addition to a primary structure, a protein comprises a secondary, tertiary, or higher structure. The amino acids of the polypeptides are most typically L-amino acids, but may also be D-amino acids, modified amino acids, amino acid analogs, amino acid mimetics, or any combination thereof. Polypeptides may be naturally occurring, synthetically produced, or recombinantly expressed. Polypeptides may be synthetically produced, isolated, recombinantly expressed, or be produced by a combination of methodologies as described above. Polypeptides may also comprise additional groups modifying the amino acid chain, for example, functional groups added via post-translational modification. The polymer may be linear or branched, it may comprise modified amino acids, and it may be interrupted by non-amino acids. The term also encompasses an amino acid polymer that has been modified naturally or by intervention; for example, disulfide bond formation, glycosylation, lipidation, acetylation, phosphorylation, or any other manipulation or modification, such as conjugation with a labeling component.

As used herein, the term “binding agent” refers to a nucleic acid molecule, a peptide, a polypeptide, a protein, carbohydrate, or a small molecule that binds to, associates, unites with, recognizes, or combines with a binding target, e.g., a polypeptide or a component or feature of a polypeptide. A binding agent may form a covalent association or non-covalent association with the polypeptide or component or feature of a polypeptide. A binding agent may also be a chimeric binding agent, composed of two or more types of molecules, such as a nucleic acid molecule-peptide chimeric binding agent or a carbohydrate-peptide chimeric binding agent. A binding agent may be a naturally occurring, synthetically produced, or recombinantly expressed molecule. A binding agent may bind to a single monomer or subunit of a polypeptide (e.g., a single amino acid of a polypeptide) or bind to a plurality of linked subunits of a polypeptide (e.g., a di-peptide, tri-peptide, or higher order peptide of a longer peptide, polypeptide, or protein molecule).

As used herein, the term “specific binding” refers to the specificity of a binder (binding agent), such that it preferentially binds to a target. When referring to a binding partner, e.g., protein, nucleic acid, antibody or other affinity capture agent, etc., “specific binding” can include a binding reaction of two or more binding partners with high affinity and/or complementarity to ensure selective hybridization under designated assay conditions. Typically, specific binding will be at least three times the standard deviation of the background signal. Thus, under designated conditions the binding partner binds to its particular target molecule and does not bind in a significant amount to other molecules present in the sample.

As used herein, the term “barcode” refers to a nucleic acid molecule of about 2 to about 30 bases (e.g., 2, 3, 4, 5, 6, 7, 8, 9, 10, 11, 12, 13, 14, 15, 16, 17, 18, 19, 20, 21, 22, 23, 24, 25, 26, 27, 28, 29 or 30 bases) providing a unique identifier tag or origin information for a polypeptide, a binding agent, a set of binding agents from a binding cycle, a sample polypeptides, a set of samples, polypeptides within a compartment (e.g., droplet, bead, or separated location), a spatial region or set of spatial regions. A barcode can be an artificial sequence or a naturally occurring sequence.

As used herein, the term “coding tag” refers to a polynucleotide with any suitable length, e.g., a nucleic acid molecule of about 2 bases to about 100 bases, including any integer including 2 and 100 and in between, that comprises identifying information for its associated binding agent. A “coding tag” may also be made from a “sequenceable polymer” (see, e.g., Niu et al., 2013, Nat. Chem. 5:282-292; Roy et al., 2015, Nat. Commun. 6:7237). A coding tag may comprise an optional UMI and/or an optional binding cycle-specific barcode. A coding tag may be single stranded or double stranded.

As used herein, the term “spacer” (Sp) refers to a nucleic acid molecule of about 1 base to about 20 bases (e.g., 1, 2, 3, 4, 5, 6, 7, 8, 9, 10, 11, 12, 13, 14, 15, 16, 17, 18, 19, or 20 bases) in length that is present on a terminus of a recording tag or coding tag. In certain embodiments, a spacer sequence flanks an encoder sequence of a coding tag on one end or both ends. Following binding of a binding agent to a polypeptide, annealing between complementary spacer sequences on their associated coding tag and recording tag, respectively, allows transfer of binding information through a primer extension reaction or ligation to the recording tag, coding tag, or a di-tag construct. Sp′ refers to spacer sequence complementary to Sp. Preferably, spacer sequences within a library of binding agents possess the same number of bases.

As used herein, the term “recording tag” refers to a moiety, e.g., a chemical coupling moiety, a nucleic acid molecule, or a sequenceable polymer molecule (see, e.g., Niu et al., 2013, Nat. Chem. 5:282-292; Roy et al., 2015, Nat. Commun. 6:7237) to which identifying information of a coding tag can be transferred, or from which identifying information about the macromolecule associated with the recording tag can be transferred to the coding tag. Identifying information can comprise any information characterizing a molecule such as information pertaining to sample, fraction, partition, spatial location, interacting neighboring molecule(s), cycle number, etc. Additionally, the presence of UMI can also be classified as identifying information.

As used herein, the term “unique molecular identifier” or “UMI” refers to a nucleic acid molecule of about 3 to about 40 bases (3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 bases) in length providing a unique identifier tag for each macromolecule, polypeptide or binding agent to which the UMI is linked. A polypeptide UMI can be used to computationally deconvolute sequencing data from a plurality of extended recording tags to identify extended recording tags that originated from an individual polypeptide.

As used herein, the term “extended recording tag” refers to a recording tag to which information of at least one binding agent's coding tag (or its complementary sequence) has been transferred following binding of the binding agent to a polypeptide. Information of the coding tag may be transferred to the recording tag directly (e.g., ligation) or indirectly (e.g., primer extension). Information of a coding tag may be transferred to the recording tag enzymatically or chemically. An extended recording tag may comprise binding agent information of 1, 2, 3, 4, 5, 10, 20, 30, 50, 100 or more coding tags.

As used herein, the term “solid support”, “solid support matrix”, or “solid substrate”, refers to any solid material, including porous and non-porous materials, to which a polypeptide can be associated directly or indirectly, by any means known in the art, including covalent and non-covalent interactions, or any combination thereof. A solid support may be two-dimensional (e.g., planar surface) or three-dimensional (e.g., gel matrix or bead). A solid support can be any support surface including, but not limited to, a bead, a microbead, a glass surface, a silicon surface, a plastic surface, a filter, a membrane, a biochip including signal transducing electronics, a channel, a microtiter well, a polymer matrix, a nanoparticle, or a microsphere. Materials for a solid support include but are not limited to acrylamide, agarose, cellulose, dextran, nitrocellulose, glass, gold, quartz, polystyrene, polyethylene vinyl acetate, polypropylene, polyester, polymethacrylate, polyacrylate, polyethylene, polyethylene oxide, polysilicates, polycarbonates, poly vinyl alcohol (PVA), Teflon, fluorocarbons, nylon, silicon rubber, polyanhydrides, polyglycolic acid, polyvinylchloride, polylactic acid, polyorthoesters, functionalized silane, polypropylfumerate, collagen, glycosaminoglycans, polyamino acids, dextran, or any combination thereof. For example, when solid surface is a bead, the bead can include, but is not limited to, a ceramic bead, a polystyrene bead, a polymer bead, a polyacrylate bead, a methylstyrene bead, an agarose bead, a cellulose bead, a dextran bead, an acrylamide bead, a solid core bead, a porous bead, a paramagnetic bead, a glass bead, a controlled pore bead, a silica-based bead, or any combinations thereof. A bead may be spherical or an irregularly shaped. A bead or support may be porous. A bead's size may range from nanometers, e.g., 100 nm, to millimeters, e.g., 1 mm. In certain embodiments, beads range in size from about 0.2 micron to about 200 microns, or from about 0.5 micron to about 5 micron. In some embodiments, beads can be about 1, 1.5, 2, 2.5, 2.8, 3, 3.5, 4, 4.5, 5, 5.5, 6, 6.5, 7, 7.5, 8, 8.5, 9, 9.5, 10, 10.5, 15, or 20 μm in diameter. In certain embodiments, “a bead” solid support may refer to an individual bead or a plurality of beads. In some embodiments, the solid surface is a nanoparticle. In certain embodiments, the nanoparticles range in size from about 1 nm to about 500 nm in diameter, for example, between about 1 nm and about 20 nm, between about 1 nm and about 50 nm, between about 1 nm and about 100 nm, between about 10 nm and about 50 nm, between about 10 nm and about 100 nm, between about 50 nm and about 200 nm, or between about 200 nm and about 500 nm in diameter. In some embodiments, the nanoparticles can be about 10 nm, about 50 nm, about 100 nm, about 200 nm, about 300 nm, or about 500 nm in diameter. In some embodiments, the nanoparticles are less than about 200 nm in diameter.

As used herein, “nucleic acid sequencing” means the determination of the order of nucleotides in a nucleic acid molecule or a sample of nucleic acid molecules. Similarly, “polypeptide sequencing” means the determination of the identity and order of at least a portion of amino acids in the polypeptide molecule or in a sample of polypeptide molecules.

As used herein, “next generation sequencing” refers to high-throughput sequencing methods that allow the sequencing of millions to billions of molecules in parallel. Examples of next generation sequencing methods include sequencing by synthesis, sequencing by ligation, sequencing by hybridization, polony sequencing, ion semiconductor sequencing, and pyrosequencing.

As used herein, “analyzing” the polypeptide means to identify, detect, quantify, characterize, distinguish, or a combination thereof, all or a portion of the components of the polypeptide. For example, analyzing a peptide, polypeptide, or protein includes determining all or a portion of the amino acid sequence (contiguous or non-continuous) of the peptide. Analyzing a polypeptide also includes partial identification of a component of the polypeptide. For example, partial identification of amino acids in the polypeptide protein sequence can identify an amino acid in the protein as belonging to a subset of possible amino acids. Analysis typically begins with analysis of the n NTAA, and then proceeds to the next amino acid of the peptide (i.e., n−1, n−2, n−3, and so forth). This is accomplished by elimination of then NTAA, thereby converting the n−1 amino acid of the peptide to an N-terminal amino acid (referred to herein as the “n−1 NTAA”). Analyzing the peptide may also include determining the presence and frequency of post-translational modifications on the peptide, which may or may not include information regarding the sequential order of the post-translational modifications on the peptide. Analyzing the peptide may also include determining the presence and frequency of epitopes in the peptide, which may or may not include information regarding the sequential order or location of the epitopes within the peptide. Analyzing the peptide may include combining different types of analysis, for example obtaining epitope information, amino acid sequence information, post-translational modification information, or any combination thereof.

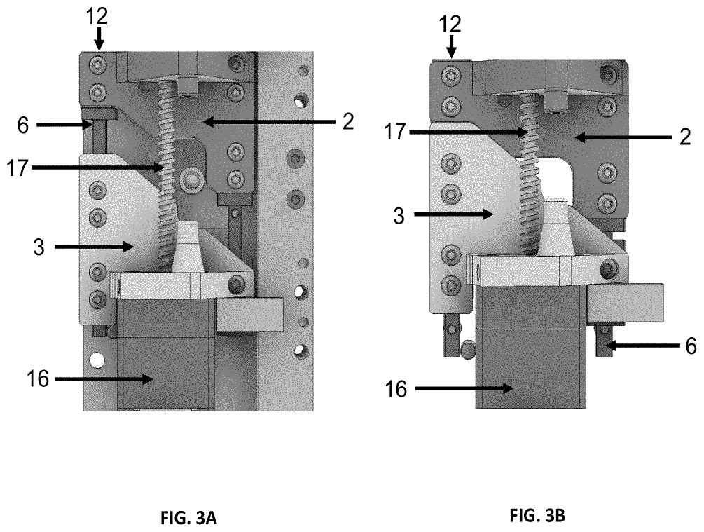

In preferred embodiments, the reaction system 50 generally comprises: (a) a reaction cartridge 1 comprising a fluidic input 4 and a fluidic output 5; (b) a fluid introduction channel 8 configured to provide a fluid to the fluidic input 4; (c) a first sealing element 2 that comprises the fluid introduction channel 8 and is configured to establish a first seal (a component of the first seal 10 is shown) between the fluidic input 4 and the fluid introduction channel 8; (d) a fluid receiving channel 9 configured to receive a fluid from the fluidic output 5; (e) a second sealing element 3 that comprises the fluid receiving channel 9 and is configured to establish a second seal (a component 11 of the second seal is shown) between the fluidic output 5 and the fluid receiving channel 9; and (f) a transport carriage 6 (shown in FIG. 3A) configured to move the first sealing element 2 and the second sealing element 3 relative to the reaction cartridge 1 such that to establish the first seal and the second seal, wherein the movement of the first sealing element 2 and the second sealing element 3 is achieved by using a single actuator 7.

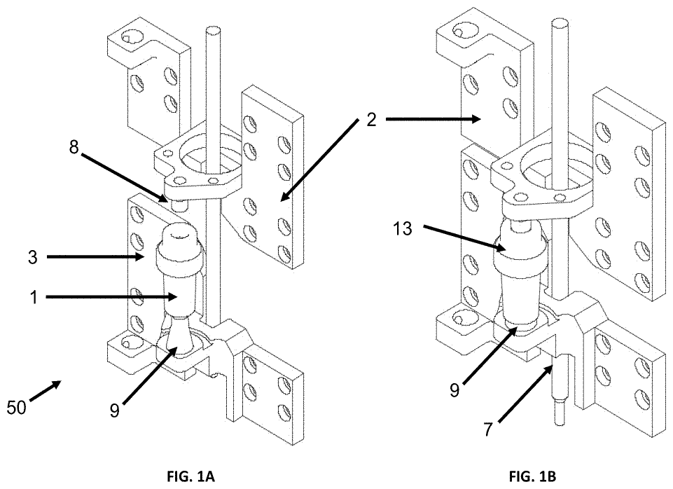

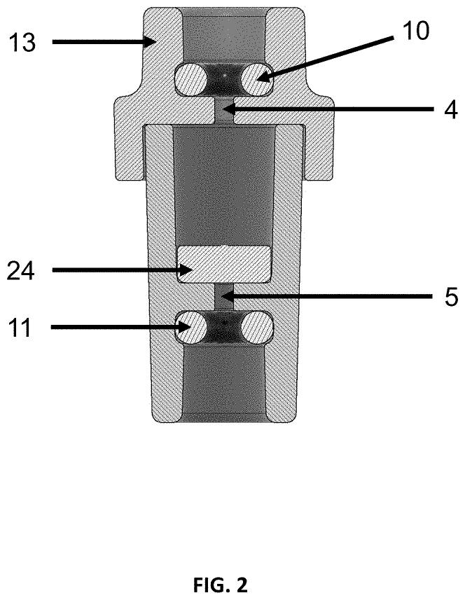

FIGS. 1A-1B and FIG. 2 illustrate some of the elements of an exemplary reaction system 50 and an exemplary reaction cartridge 1, respectively. FIG. 1A shows an open state of the exemplary reaction system 50, and FIG. 1B shows a partially closed state of the exemplary reaction system 50, where fluid introduction channel 8 starts engaging with the fluidic input 4 of the reaction cartridge 1. The reaction cartridge 1 shown in FIG. 2 further comprises one or more filter means 24 preventing analytes on a solid support matrix 22 to escape from the reaction cartridge 1. In preferred embodiments, the reaction cartridge 1 also comprises a cap 13 which is attached to a body of the reaction cartridge 1 via a threaded connection. In some embodiments, the reaction cartridge 1 is inserted into the reaction system 50 with a cartridge carrier 14. In some embodiments, the reaction system 50 may also include photoelectric sensors 15.

FIG. 3A and FIG. 3B provide additional views of the exemplary reaction system 50 without the reaction cartridge 1. FIG. 3A shows an open state of the exemplary reaction system 50, where the sealing elements 2 and 3 are separated apart. In this particular embodiment, the single actuator 7 comprises a motor 16 and a lead screw 17. FIG. 3B shows a closed state of the exemplary reaction system 50 (without the reaction cartridge 1), where the sealing elements 2 and 3 came together. In this particular embodiment, the transport carriage 6 moves along a guide rail 12 in order to engage the first sealing element 2 and the second sealing element 3.

In some embodiments, the reaction system 50 is located inside an instrument 60 for analysis of biological macromolecules, such as polypeptides. In some embodiments, the reaction system 50 further comprises spring-based biaser, upper cartridge guide fork and press device, and/or thermal control block, according to various embodiments of the invention.

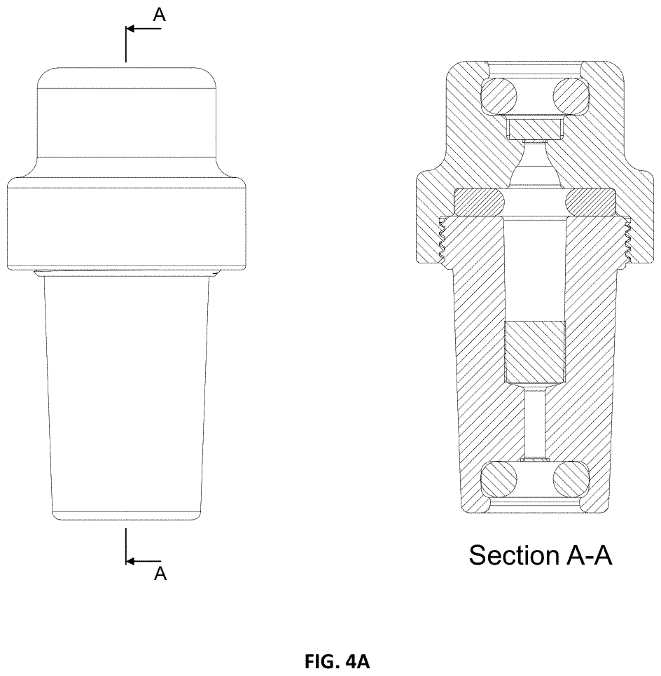

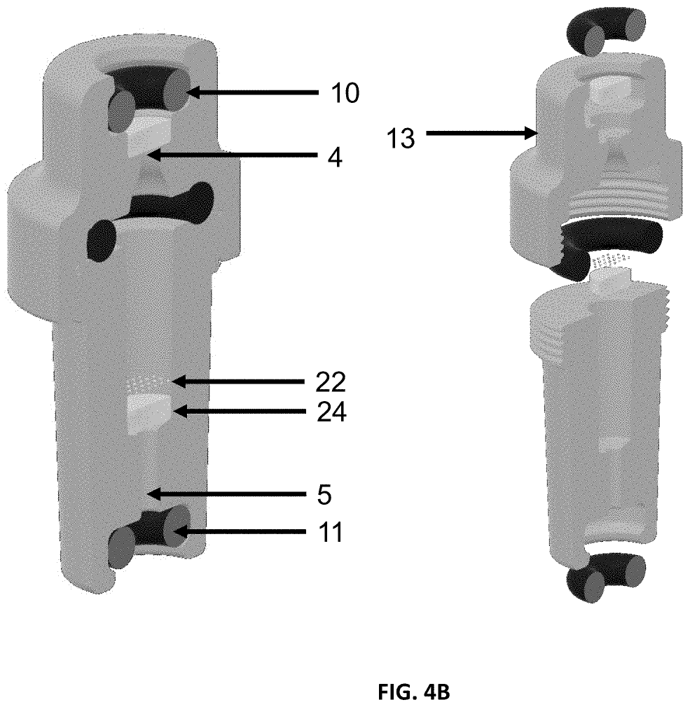

FIG. 4A and FIG. 4B show another exemplary embodiment of reaction cartridge 1. In this embodiment, reaction cartridge 1 comprises cap 13 having an extra sealing means (O-ring) and two different filter means 24. This design allows for fluidic movement in both directions through the reaction cartridge 1 (from fluidic input 4 to fluidic output 5, and in reverse direction).

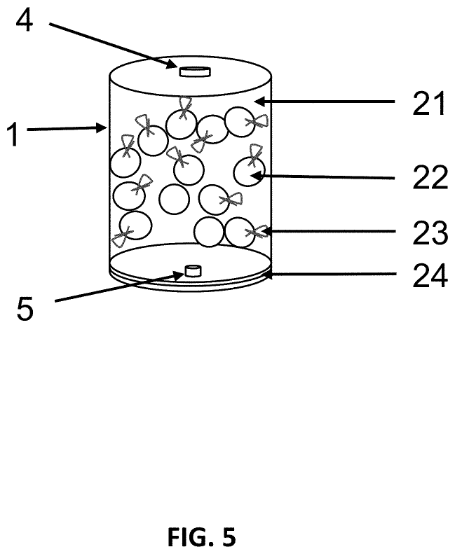

FIG. 5 shows an exemplary variant of the reaction cartridge 1 comprising fluidic input 4 and fluidic output 5, further comprising an interior chamber 21 with a solid support matrix 22, reagent 23 immobilized on the solid support matrix 22, and a filter means 24 preventing solid support matrix 22 to escape reaction cartridge 1.

In an exemplary reaction system, a sample is loaded into a reaction cartridge 1, the cartridge 1 is then placed into the reaction system 50 and leak-resistant fluidic connections (first seal and second seal) are established between the fluidic input 4 of the cartridge 1 and the fluid introduction channel 8 of the reaction system 50, and between the fluidic output of the cartridge 5 and the fluid receiving channel 9 of the reaction system 50, respectively.

In preferred embodiments, the fluid introduction channel 8 of the reaction system 50 establishes a fluidic communication between one or more of reagent reservoirs located outside of the reaction system 50 and the reaction cartridge 1, whereas the fluid receiving channel 9 of the reaction system 50 establishes a fluidic communication between the reaction cartridge 1 and a waste container or a collection container.

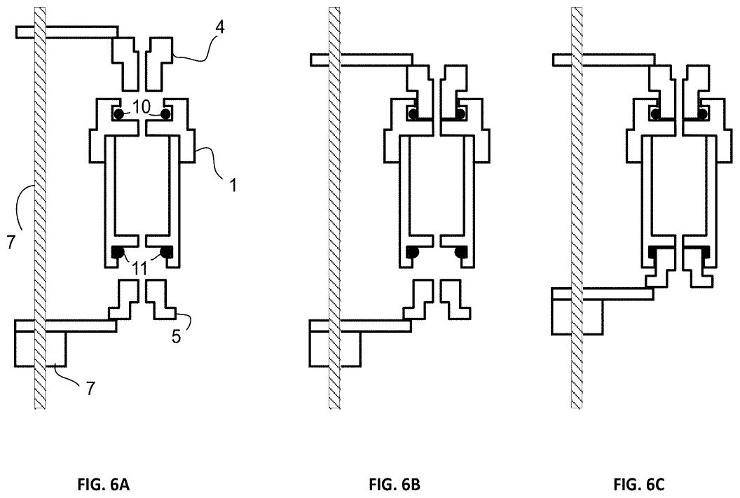

FIG. 6A-FIG. 6C illustrate the reaction cartridge 1, fluidic input 4 and fluidic output 5 at three different stages of the sealing process (process of establishing the seals). In FIG. 6A both the fluidic input 4 and fluidic output 5 are disengaged from reaction cartridge 1 and reaction cartridge 1 is free to be moved using cartridge carrier 14. In FIG. 6B single actuator 7 has been used to reduce the distance between fluidic input 4 and fluidic output 5 such that at least one of fluidic input 4 and fluidic output 5 form a seal with reaction cartridge 1 using, for example, O-ring 10. Note that in various embodiments, either of fluidic input 4 and fluidic output 5 may form a seal before the other. Optionally, a spring, gravity, and/or similar mechanism may be used to bias the movement of fluidic input 4 and fluidic output 5 to determine which seals to reaction cartridge 1 first. In FIG. 6C both seals between fluidic input 4, reaction cartridge 1 and fluidic output 5 have been established. The establishment of both seals is optionally detected by sensors 15.

The single actuator 7 is configured to alternatively separate and bring closer the fluidic input 4 and fluidic output 5. This may be accomplished, using a screw, rod or other connector (17). The single actuator 7 can engage the connector 17 to move the other components (such as sealing elements 2 and 3, or fluidic input 4 and fluidic output 5) apart or towards each other by a number of standard ways known in the art. In preferred embodiments, the transport carriage 6 and guide rail 12 are used to transfer motion of single actuator 7 to sealing elements 2 and 3. In different embodiments, single actuator 7 can be attached to different parts of the reaction system. In some embodiments, single actuator 7 can be attached to sealing elements 2 or 3, or to both elements 2 and 3. In some embodiments, single actuator 7 can be attached to fluidic input 4 or output 5, or to both elements 4 and 5. In some embodiments, single actuator 7 can be attached to an outer housing of the instrument. In some embodiments, single actuator 7 can be free-floating. In different embodiments, sensors 15 can detect positions of different elements during establishing the first and second seals, or during breaking the first and second seals. In some embodiments, sensors 15 can detect position of the transport carriage 6 relative to the reaction cartridge 1. In some embodiments, sensors 15 can detect positions of sealing elements 2 and 3 during establishing the seals.

Examples of reaction cartridge 1 include suitable non-planar cartridges of various materials and shapes. In some embodiments, the reaction cartridge 1 is compatible for use with a solid support matrix 22 which comprises a three-dimensional material (e.g., a gel matrix or a bead). The reaction cartridge 1 can be loaded with a sample that contains macromolecules immobilized on a support. In some embodiments, it is preferred to immobilize the macromolecules from the sample using a three-dimensional support (e.g., a porous matrix or a bead). In some cases, desirable properties for the interior walls of the reaction cartridge include low or negligible binding for proteins. Desirable properties for the interior walls of the cartridge may include modified surface characteristics to improve reaction exchange efficiency, accelerate reactions, and reduce adhesion of the solid support matrix 22. The treatment of the interior walls may be performed by application of a polymer or other material with favorable surface properties, or by a modification of the base material's surface finish—for example through plasma treatment or media blasting. In some cases, it is desirable that the material of the reaction cartridge 1 is inert to chemicals (e.g. to any chemical treatments used for peptide analysis). In some particular embodiments, the reaction cartridge 1 is made of a material that is compatible with or transparent to microwave application. For example, the reaction cartridge 1 can be made of a material that comprises glass, a glass-like material (e.g., fused silica, borosilicate, quartz), polyethylene, polyether ether ketone (PEEK), and polytetrafluorethylene (PTFE), fluorinated hydrocarbon plastics, or any combination thereof. In some particular embodiments, the reaction cartridge 1 can be made of metal, such as stainless steel or titanium. Preferably, the reaction cartridge 1 is made of a heat-conductive material, since reactions in the reaction cartridge 1 are performed at different temperatures, and the reaction cartridge 1 is subjected to active heating and cooling. Some reactions disclosed herein require temperatures from 15 to 95° C.; some reactions disclosed herein require temperatures from 20 to 30° C.; other reactions disclosed herein require temperatures from 30 to 40° C.; yet other reactions disclosed herein require temperatures from 50 to 85° C.

In some embodiments, a fluid is provided to the fluidic input 4 of the reaction cartridge 1, and the same fluid comes out of the fluidic output 5 of the reaction cartridge 1. Examples of such fluid include water or a buffer solution. In other embodiments, one fluid is provided to the fluidic input 4 of the reaction cartridge 1, and fluid with a modified composition comes out of the fluidic output of the reaction cartridge. Examples of such fluid that change composition after passing through the reaction cartridge include fluids that comprise one or more reagents that undergo reaction(s) inside the reaction cartridge or can interact with components inside the reaction cartridge. For example, a buffer solution comprising a second reagent enters the reaction cartridge, and the buffer solution with a greatly reduced concentration of the second reagent exits the reaction cartridge, since the second reagent interacts with the first reagent immobilized on the solid support matrix 22 inside the reaction cartridge.

In some embodiments, the mode of delivery of fluids (e.g., water, buffers or reagents) to the reaction cartridge 1 is a discrete and non-continuous flow. In some cases, this discrete and non-continuous flow is advantageous for exchange of fluids applied to the reaction cartridge and removal of reagents from the reaction cartridge. For example, a first reagent may be delivered to the reaction cartridge, and after incubation, the first reagent can be nearly completely evacuated from the reaction cartridge before a second reagent is delivered to the reaction cartridge, thereby reducing the amount of mixing between the first and second reagents. This discrete delivery and removal of reagents to and from the reaction cartridge may create an air gap in the reaction cartridge. In some embodiments, the reaction cartridge 1 has a vent or valve, or a number of vents/valves, either each singularly interacting with the cartridge or interacting through a series arrangement with a number of valves and ultimately the cartridge. For example, the reaction cartridge has a valved opening. In some cases, the reaction cartridge may comprise a valved opening to atmospheric pressure. The vent or valve may be useful in some cases to release pressure displaced by fluid entering the reaction cartridge. In some specific embodiments, the reaction cartridge 1 has a vent or valve that opens to atmospheric pressure so that a reagent can be pulled out of cartridge and replaced by air, prior to delivery of the next reagent or wash buffer to the reaction cartridge. In other embodiments, the flow of fluid into the reaction cartridge is continuous. The reaction cartridge 1 may be subjected to positive pressure, such as applied by a pump. The same pump may also be able to subject the cartridge to reduce pressure (local vacuum) so as to control the flow of fluid in both in and out directions by running in the reverse direction. In some embodiments, the movement of the fluid to and from the sample container is controlled using a pump, which can move the fluid into the sample container using either positive or negative pressure.

In preferred embodiments, the reaction cartridge 1 is a sealed cartridge. One advantage of a sealed cartridge and/or system is the prevention of leaks. The reaction cartridge 1, in some cases, can be under negative pressure. For example, a pump can be positioned downstream of the reaction cartridge to apply negative pressure to the reaction cartridge. Some benefits with a reaction cartridge that is subjected to negative pressure may include improved flow characteristics, especially with a reaction volume that is about 50 μL to about 100 μL. The downstream pump may run continuously as reagents are pumped into the cartridge, or may run sporadically and aid a vent or valve in purging air or other reagents from the cartridge. In some aspects, other desired features might be a sample contained that is easier, faster, better controlled, and/or more efficient to deliver reagents to and/or drain.

In some embodiments, the reaction system 50 comprises a fluid pump configured to move fluid through the reaction cartridge in both directions, such as from the fluidic input 4 to the fluidic output 5, or, if needed, in the reverse direction. The use of reverse flow allows for actively mixing liquid reagent(s) to enhance chemical or enzymatic reaction efficiency, improving washing efficiency, and, sometimes, for eluting a reaction product through the fluidic system for delivery into containers elsewhere in the system.

In some embodiments, the reaction system 50 with the reaction cartridge 1 is located vertically (in upright position) within the instrument 60, so the first sealing element 2 is located above the second sealing element 3. In other embodiments, the reaction system 50 with the reaction cartridge 1 is located horizontally within the instrument 60, so centers of the first sealing element 2 and the second sealing element 3 are located on the horizontal plane. In some embodiments, a reaction cartridge 1 is characterized by: a) having at least one dimension (e.g., length, width, or diameter) that is greater than its height; b) having a ratio between the height and largest dimension (e.g., length, width, or diameter) from about 1:2 to about 1:10, from about 1:2 to about 1:50, from about 1:2 to about 1:100, or from about 1:2 to about 1:500; and/or c) having a thickness or height of equal to or less than 1 mm. In some embodiments, the non-planar reaction cartridge 1 configured for use with the provided reaction system 50 is characterized by: a) having at least one dimension (e.g., length, width, or diameter) that is less than its height; b) having a ratio between the height and largest dimension (e.g., length, width, or diameter) from about 1:1 to about 10:1, from about 1:1 to about 20:1, from about 1:1 to about 50:1, or from about 1:1 to about 100:1; and/or c) having a thickness or height of greater than 1 mm. A planar cartridge 1 may have minimal height (e.g., depth or thickness) between the top and bottom of the cartridge to allow continuous laminar flow.

In some embodiments, the top and the bottom of the reaction cartridge 1 comprise a fluidic input 4 (inlet) for delivery of reagents and a fluidic output 5 (outlet) for evacuation of reagents or sample collection. In some embodiments, the fluidic input 4 of the cartridge can also be used for the initial delivery of the sample to the reaction cartridge. In some embodiments, the fluidic output 5 of the reaction cartridge is configured for draining fluid from the reaction cartridge to a waste container. In some cases, the waste container is fluidically connected to one or more reaction cartridges, directly or indirectly. In some embodiments, each reaction cartridge is a disposable or replaceable component of the reaction system. In some embodiments, the reaction cartridge 1 is not a slide on which a planar sample is deposited. In some embodiments, the reaction cartridge 1 has a volume (e.g., capacity or the internal volume of the container) equal to or less than about 50 ml, equal to or less than about 20 ml, equal to or less than about 10 ml, equal to or less than about 5 ml, equal to or less than about 2 ml, equal to or less than about 1 ml, equal to or less than about 0.5 ml, or equal to or less than about 0.25 ml, or equal to or less than about 0.1 ml, or equal to or less than about 0.05 ml.

In some embodiments, the reaction cartridge 1 comprises a body containing an interior chamber, and a cap for placing objects into the interior chamber of the reaction cartridge 1. In some embodiments, the reaction cartridge 1 further comprises means or devices that help to establish the seals between the fluidic input 4 and the fluid introduction channel 8, and between the fluidic output 5 and the fluid receiving channel 9 of the reaction system 50. Such means or devices may include O-rings (shown in FIG. 2 as elements 10, 11) or gaskets.

In some embodiments, the fluidic input 4 and the fluidic output 5 of the reaction cartridge 1 are disposed on the opposite sides of the reaction cartridge 1. In some embodiments, the fluidic input 4 can become the fluidic output 5 and the fluidic input 5 can become the fluidic output 4 just by changing the direction of fluidic flow within the system 50 and the cartridge 1. This change in flow direction can be accomplished under a flow control of the system 50 by a control unit, allowing the flow to go from one direction to another, or in reverse.

In different embodiments, both the fluidic input 4 and the fluidic output 5 can be either a male- or female-type connection. In some embodiments, the fluidic input 4 and output 5 connections are tapered. In some embodiments, the taper of the input or output connections can be between 1% and 10%. In some embodiments, the taper of the input or output connections is conical or cylindrical. In some embodiments, the bottom of connection fitting can be flat-bottomed or conical in shape. In some embodiments, the mating connection of the fluid introduction channel 8 is complimentary to the fluidic input connection of the reaction cartridge. In some embodiments, the mating connection of the fluid receiving channel is complimentary to the fluidic output connection of the reaction cartridge. In some embodiments, the internal diameter of interior fluidic passage for both mating connections is between 0.1 and 3.0 mm. In some embodiments, the internal diameter of interior fluidic passage for both mating connections is kept to a minimum to reduce swept volume. In some embodiments, the length of the fluidic channel is kept to minimum to reduce swept volume, typically between 10 and 100 mm.

In some embodiments, the first sealing element 2 comprises the fluid introduction channel 8 and a second sealing element 3 comprises the fluid receiving channel 9 of the system 50. In some embodiments, the single actuator 7 is configured to move two sealing elements 2 and 3 together. In some embodiments, the single actuator 7 can be attached to both of the sealing elements 2 and 3. In one specific embodiment, the second sealing element 3 is attached to the immobile part of the actuator, and the first sealing element 2 is attached to the lead screw 17 of the actuator. When the actuator 7 turns in a particular direction, the two sealing elements 2 and 3 are brought together. When the actuator 7 turns in the opposite position, the two sealing elements 2 and 3 come apart. Other attachment configurations are possible in other specific embodiments.

In some embodiments, both the first and the second sealing elements 2 and 3 of the reaction system 50 receive a standard fluidic connection, such as a flat-bottomed ¼-28 or 6-40 fluidic fitting.

In some embodiments, upon insertion of the reaction cartridge 1 into the system 50, the linear actuator 7 is activated such that the first sealing element 2 moves to engage the reaction cartridge 1, and the second sealing element 3 moves to engage the transport carriage 6 until the fluid receiving channel 9 is aligned with the fluidic output 5 and the fluid introduction channel 8 is aligned with the fluidic input 4, and a leak-resistant fluid communication is established between the fluid introduction channel 8, the reaction cartridge 1 and the fluid receiving channel 9.

In some embodiments, the system 50 is configured such that the first seal and the second seal are established at different times. The system may automatically account for pressurization of the system during sealing by venting, either passively or by use of a pump, vacuum, or diaphragm displacement which accounts for the pressurization. In some embodiments, control of the order of sealing is accomplished by introducing bias for either the first seal or the second seal. Bias can be accomplished by methods known in the art, such as by introducing a differential mass, increasing friction or springs for one of two sealing elements 2 and 3, or by engaging/disengaging with the actuator. In one particular embodiment, introduction of the bias will cause the actuator 7 to engage the first sealing element 2 first, followed by engagement of the second sealing element 3, due to increased friction of the second sealing element 3. In some embodiments, the reaction system 50 further comprises spring mechanism configured such that the first seal and the second seal are established at different times. A simple linkage known in the art may be used to accomplish the sequential action, for example, a four-bar linkage. In some embodiments, the spring mechanism controls a position of one of the sealing elements 2 and 3 relative to a base of the reaction system, or relative to a height of the cartridge carrier 14. In some embodiments, the bias can be introduced during unsealing process, when the first seal or the second seal are broken at different times. The bias during unsealing process involves similar mechanisms, such as introducing a differential mass, increasing friction or springs for one of two sealing elements 2 and 3. In some embodiments, the system may automatically account for depressurization of the system during unsealing by venting, either passively or by use of a pump or some other form of displacement to account for the depressurization.

In some embodiments, the transport carriage 6 of the reaction system 50 is attached to the guide rail 12 or linear shaft. In some embodiments, the carriage 6 can have ball- or sleeve bearings, or constructed from a low-friction plastic. In some embodiments, the carriage 6 can utilize a linear bearing instead of a carriage. This linear bearing can be ball- or sleeve bearing, or constructed from a low-friction plastic. In some embodiments, the transport carriage 6 maintains alignment of the sealing elements 2 and 3 during the sealing process.

In some embodiments, the guide rail 12 forms a functional connection with the transport carriage 6. The carriage 6 is attached to the guide rail 12 with a groove in both sides of the rail 12, with the mating groove in the carriage 6. Ball-, sleeve-, roller- or other type of bearings are in constant contact between the rail 12 and the carriage 6, facilitating low-friction movement in any orientation. In some embodiments, the rail 12 is firmly attached to a surface with screws at close spacing, for example with a 9 mm wide rail, screws are attached every 10 mm. The carriage may be attached directly to the actuator or may be driven by a linkage which is in turn driven by the actuator—for example a four bar linkage.

In some embodiments, the transport carriage is configured to establish the first and second seals only when the reaction cartridge is held in place.

In some embodiments, the reaction cartridge 1 is composed of two or more parts that are sealed together by adhesive, melting, fusion bonding (e.g. welding) or by mechanical fastening. Different methods of sealing are known in the art. In some embodiments, sealing mechanism can comprise either a slip-fit held together by friction, gaskets or O-rings, or threaded. In some embodiments, adhesives can include or cyanoacrylate, urethane, polyvinyl alcohol, natural rubber, polychloroprene, thermoplastic glues, silicones, epoxy glues and adhesives, and could also include pressure sensitive adhesives. In some embodiments, fusion bonding can include ultrasonic, spin, induction, or dielectric welding, or by local melting and then joining of the adjoining plastic pieces using heat, light, or solvents. In some embodiments, mechanical fastening can include the addition of threads, or by incorporation of another fastening element, such as a latch, hinge, or detent. In some embodiments, a user can put reaction reagents (including those immobilized on a solid support matrix 22) into the interior chamber of the reaction cartridge 1 and then close the reaction cartridge by placing a cap and sealing it.

In some embodiments, O-rings are embedded in the reaction cartridge 1. As shown in FIG. 2 and FIG. 6A, O-rings 10 and 11 can be components of the first seal and the second seal, respectively. In some embodiments, the first seal is created by interaction between the first sealing element 2 comprising fluid introduction channel 8, the reaction cartridge 1 comprising fluidic input 4, and the sealing component 10. In some embodiments, the second seal is created by interaction between the second sealing element 3 comprising fluid receiving channel 9, the reaction cartridge 1 comprising fluidic output 5, and the sealing component 11. In some embodiments, O-rings 10 and 11 are disposed the sides of the female connections of fluidic input 4 and the fluidic output 5. In some embodiments, O-rings are used to minimize the dead volume between the reaction cartridge 1 and male connectors.

In some embodiments, the sealing is accomplished with friction. In some embodiments, the sealing mechanism comprises either flat-bottom or conical shaped seals. In some embodiments, the sealing mechanism can comprise gaskets or O-rings. In some embodiments, gaskets or O-rings are made from rubber, buna-n (nitrile or another type of a synthetic rubber), silicone, polyurethane, fluoropolymers, or fluoropolymer elastomers. Gaskets or O-rings can increase efficiency of the seals established by movement of the sealing elements of the system. In some embodiments, gaskets or O-rings can be a part of the reaction cartridge.

In one particular embodiment, creating the first and the second seal comprises the following steps: the cartridge 1 with sealing O-rings on the fluidic input 4 and fluidic output 5 of the cartridge 1 is inserted into the reaction system 50; the single linear actuator 7 is activated such that the first sealing element 2 moves to engage the fluidic input 4 of the cartridge; once the fluidic input 4 generates enough resistance to overcome the inherent friction of the first sealing element 2, the second sealing element 3 moves upwards to engage the fluidic output 5 of the cartridge 1; once the fluidic output 5 of the cartridge 1 is engaged, final sealing of the cartridge is obtained by driving the actuator 7 to a sealing-endpoint by pre-calibration of the sensors 15. Alternatively, final sealing of the cartridge 1 can be obtained by encoder feedback or by monitoring the actuator current. Once sealed, the cartridge 1 can received fluidics delivered under positive or negative pressure. In some embodiments, actual motor current of the actuator provides feedback for the sealing endpoint.

The dual-sealing assembly described herein enables the use of fewer parts and a simpler control unit, since it is achieved by a single motion of a single actuator. The use of fewer parts and simpler control system allow for a very compact sealing mechanism and could also increase reliability, will be easier to manufacture as it will require less manufacturing testing and calibration, and is more tolerant of variance in the part being sealed (the reaction cartridge). There are several different types of single actuators, sensors, components of the transport carriage that could be used as a substitute for the specific components described herein.

In some embodiments, the carriage 6 is configured to move the sealing elements 2 and 3 during establishment of the seals, while the cartridge 1 remains stationary. In other embodiments, the carriage 6 is configured to move the cartridge 1, while one of the sealing elements 2 and 3 remains stationary during establishment of the seals.

In some embodiments, the single actuator 7 of the reaction system 50 can be a pneumatic- and air-driven actuator. In some embodiments, the single actuator 7 comprises a motor. In some embodiments, the actuator 7 can be driven by hand, for example by operating a lever, screw, handle, knob or wheel. In some embodiments, the actuator 7 is a linear actuator. In some embodiments, the single actuator 7 of the reaction system 50 is a single-axis linear actuator. The linear actuator can be driven by a stepper-, servo-, or electric-(DC or AC) motor. The linear actuator can also be driven by solenoid, air cylinder, or hydraulic jack. The linear actuator can contain a lead- or ball-screw. In one particular embodiment, the single actuator 7 comprises a motor, a lead screw and a nut. In another particular embodiment, the linear actuator is a single NEMA8 stepper motor with a non-captive M3 lead screw.

In some embodiments, the operation of the reaction system 50 can be automated. In some embodiments, particular steps of the operation of the reaction system 50 can be automated, such as movements generated by the single actuator, the first and/or second sealing element(s), and others.

In various embodiments, different systems are used to transport the reaction cartridge 1 into a correct place within the reaction system 50. In some embodiments, the reaction system 50 comprises a cartridge carrier 14 configured to transport the reaction cartridge 1 within the reaction system 50. In some embodiments, the cartridge carrier 14 with the cartridge 1 is configured to slide and/or rotate during placing the cartridge 1 within the reaction system 50. In other embodiments, the cartridge 1 can be pushed into a socket with no sliding carrier. In some embodiments, placing the cartridge carrier 14 can be achieved by a second actuator. In some embodiments, placing the cartridge carrier 14 can be automated. In some embodiments, types of the cartridge carrier 14 can include mechanical/manual drawer or automated drawer with actuator. In some embodiments, movement of the cartridge carrier 14 can by utilized to establish one of the seals. In some embodiments, the cartridge carrier 14 is a part of a cartridge loader system that comprises a reaction cartridge-carrier assembly, the spring-like cartridge carrier biaser and the spring-like cartridge carrier fork.

In some embodiments, the system 50 further comprises one or more sensors, such as sensors 15, configured to detect a position of the transport carriage 6 relative to the reaction cartridge 1. In some embodiments, exemplary sensors 15 include microswitches, photoelectric or other optical sensors, Hall Effect sensors. In some embodiments, positioning of the actuator 7 can be accomplished by end stop sensors and/or by positioning encoders (both rotary or linear), or by actuator control feedback such as step counting. In some embodiments, the sensors 15 indicate the first seal fully disengaged and/or fully engaged. In some embodiments, the sensors 15 indicate the second seal fully disengaged and/or engaged. In preferred embodiments, the sensors 15 are standard and known to those skilled in the art. In some embodiments, the sensors 15 precisely sense a position by the depressing of a microswitch or by interrupting a small beam of light (when something moving depresses the switch or moves into the light path to interrupt the light). The sensing is detected by a control system.

In some embodiments, the system 50 further comprises a fluid pump configured to move fluid through the reaction cartridge 1 via the fluidic input 4. In some embodiments, the fluid pump is a positive displacement pump such as a syringe, diaphragm, piston, peristaltic or rotary vane pump. In some embodiments, the flow rate supported by the fluid pump is between 1 and 1000 μL/sec.

In some embodiments, the system further comprises a control unit configured for controlling the actuator 7 and the pump such that the fluid is not moved through the reaction cartridge 1 unless the first and second seals are established. In some embodiments, fluids are not introduced into the reaction cartridge unless the first and second seals are in the engaged position, as indicated by the appropriate sensors and/or by encoder readings. The use of an encoder is known to those skilled in the art. In some embodiments, the encoder can be used as follows. Steppers are digital motors used when the user instructs the motor to move a certain number of pulses or “steps”. This movement can be very precise and accurate under certain conditions. But sometimes the motor “stalls” or “slips”—in these cases the actual position of the motor is different than the steps counted. An encoder provides independent verification and control of the actual position of the motor and the motor is driving (for example, a lead screw with carriage) by providing an electrical counting of absolute position. In some embodiments, use of a pressure sensor may provide confirmation of sealing by comparing the pressure reading to an expected reading for a correctly sealed cartridge, and may detect cartridges/carriages with damaged sealing interfaces by the same means.

In some embodiments, the reaction system further comprises a solid support matrix 22 disposed within an interior chamber of the reaction cartridge; and a reaction reagent attached to the solid support matrix 22. In some embodiments, the reaction system further comprises one or more filter means 24 and configured to prevent the solid support matrix 22 from leaving the reaction cartridge 1.

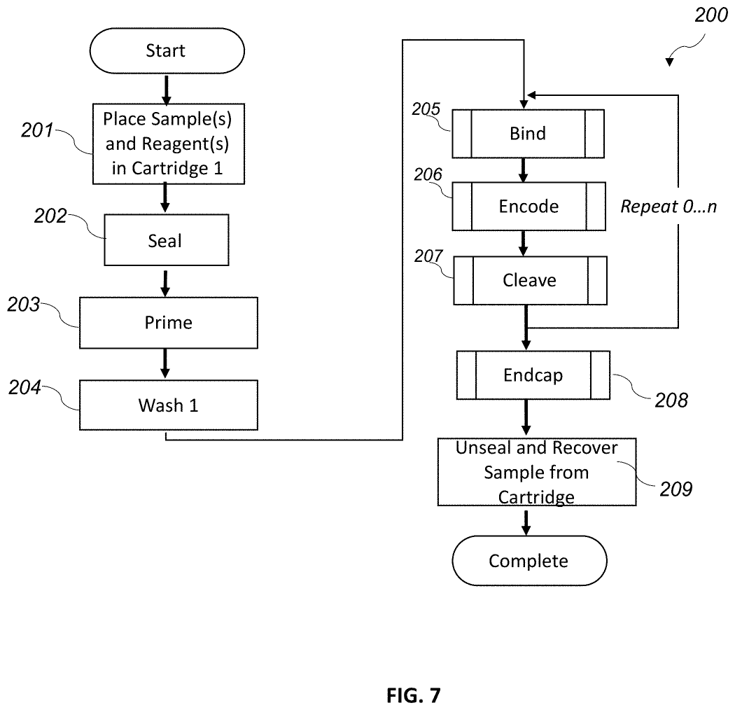

In some embodiments, a method of reacting a first reagent and a second reagent in a reaction cartridge is provided, the method comprising: (a) placing the reaction cartridge in an reaction system, wherein the reaction cartridge comprises a fluidic input and a fluidic output, and further comprises within an interior chamber the first reagent attached to a solid support matrix; and wherein the reaction system comprises: (i) a fluid introduction channel configured to provide a fluid to the fluidic input; (ii) a fluid receiving channel configured to receive the fluid from the fluidic output; and (iii) a transport carriage configured to move the fluid introduction channel and the fluid receiving channel relative to each other; (b) activating a single actuator configured to move the fluid introduction channel and the fluid receiving channel to the fluidic input and the fluidic output respectively, so as to establish a first seal between the fluid introduction channel and the fluidic input and to establish a second seal between the fluid receiving channel and the fluidic output; and (c) introducing the second reagent to the reaction cartridge via the fluidic input by pumping a fluid comprising the second reagent to the reaction cartridge. An example of reaction process between a first reagent and a second reagent in a reaction cartridge is shown in FIG. 7, and described in detail below (see Example 3).

In some embodiments of the method, the first seal and the second seal are established simultaneously. In some embodiments of the method, the first seal and the second seal are established at different times. In some embodiments of the method, the first sealing element comprises the fluid introduction channel 8 and the second sealing element comprises the fluid receiving channel; the single actuator is configured to move these two sealing elements together; and the reaction cartridge is disposed between the two sealing elements. In some embodiments of the method, the single actuator is attached to one of the two sealing elements. In some embodiments of the method, the single actuator is attached to both of these sealing elements. In some embodiments of the method, the transport carriage is attached to a guide rail or pair of linear guide rails. In some embodiments of the method, a plurality of carriages are attached to the pair of linear guide rails. In some embodiments of the method, both the first and the second sealing elements are attached to the guide rail or the pair of guide rails through the linear carriages from the plurality of linear carriages. In some embodiments of the method, both the first and the second sealing elements of the reaction system receive a standard fluidic connection, such as a flat-bottomed ¼-28 or 6-40 fluidic fitting. In some embodiments of the method, sensors and hard stops provide positional feedback on the location of the first and the second sealing elements of the reaction system.

In some embodiments, the method further comprises transporting the reaction cartridge to a position between the two sealing elements by a cartridge carrier, wherein the reaction cartridge is held in place by the cartridge carrier during establishment of the first and second seals. In some embodiments, the method further comprises detecting that the first and second seals are established using a sensor.

In some embodiments, the method further comprises breaking the first seal and the second seal. In a particular preferred embodiment, the single actuator is used to break the first seal and the second seal. In some embodiments, the method further comprises recovering a product generated after reacting the first reagent and the second reagent from the reaction cartridge and subjecting the product to a next generation sequencing procedure.

In some embodiments of the method, the first seal and the second seal are broken at different times. If the sealing elements (and corresponding fluidic input 4 and output 5) are pulled apart, one seal will break first, followed by the other. In some embodiments, there is a stop that transfers motion to the second seal. In some embodiments of the method, breaking the first seal and the second seal is performed in a similar manner as the first seal and the second seal are established (e.g. by reversing the steps that resulted in establishing the seals).

In some embodiments, the first reagent is a polypeptide, and the second reagent is a binding agent configured to bind to a portion of the polypeptide. In some embodiments, the first reagent is a polypeptide, and the second reagent is a reagent for transferring information, such as a ligation reagent. In some embodiments, the first reagent is a polypeptide, and the second reagent is a binding agent configured to bind to a N-terminal amino acid (NTAA) of the polypeptide. In some embodiments, the first reagent is a polypeptide, and the second reagent is a reagent for removing a terminal amino acid of a polypeptide.

In some embodiments, the first reagent is attached to the solid support matrix 22 disposed within an interior chamber of the reaction cartridge. In some embodiments, the reaction cartridge comprises one or more filter means 24 configured to prevent the solid support matrix 22 from leaving the reaction cartridge 1. In some embodiments, the method further comprises steps of removing or recovering a product generated after reacting the first reagent and the second reagent from the reaction cartridge and subjecting the product to a next generation sequencing. In some particular embodiments, the product is a polynucleotide generated after reacting the first reagent and the second reagent in the reaction cartridge 1. In some particular embodiments, the product is a polynucleotide generated after binding of the binding agent to the N-terminal amino acid (NTAA) of the polypeptide attached to the solid support matrix 22 in the reaction cartridge 1.

In some embodiments, the reaction cartridge 1 can be inserted into a reaction system 50 of an instrument 60 for preparing or treating macromolecules (e.g., polypeptides). In some embodiments, the reaction system 50 is used to carry out one or more steps of a macromolecule analysis assay (e.g., a polypeptide analysis assay) in an automated manner. The macromolecules analysis assay may include a cyclic process for treating the sample, wherein the process includes various repeated steps. The provided reaction system 50 automates at least some of the repeated steps of the assay such that real-time input and control from a user is reduced. The reaction system 50 may reduce the amount of time required from a user to perform the macromolecule analysis assay compared to a manual method performed without the reaction system. In some cases, the macromolecule analysis assay comprises nucleic acid encoding of molecule recognition events. In some cases, the provided reaction system is for use in treating, preparing, and/or modifying a macromolecule from a sample for sequencing and/or other analysis that employs molecular barcoding. In an exemplary workflow for analysis of the polypeptide analytes, a large collection of polypeptides (e.g., 50 million-1 billion) or more can be treated and analyzed using the automated methods and/or reaction system provided herein. In some embodiments, the reaction system is configured to integrate performing any combinations of the following: enzymatic reaction, an aqueous-phase biochemical reaction, and/or an organic reaction. In some embodiments, high throughput polypeptide sequencing reactions are performed in the reaction cartridge, such as disclosed in US 20190145982 A1, US 20200348308 A1, US 20200348307 A1, WO 2020/223000, the contents of which are incorporated herein by reference in its entirety.

In some embodiments, the instrument 60 further includes one or more reagent reservoirs for containing a respective reagent. In some examples, the reagent reservoirs may contain any or all of the following: buffers, wash buffers, polypeptides, nucleic acids, binding agents, enzymes, chemical reagents for modifying an amino acid, chemical reagents for cleaving one or more amino acids, enzymatic reagents for cleaving one or more amino acids, reagents for a ligation reaction, reagents for a polymerase-mediated reaction, or any combinations thereof. In some embodiments, once inserted into the reaction system 50, the reaction cartridge 1 is configured to be in fluid communication with the reagent reservoirs that allows for controlled supply of necessary reagents into the reaction cartridge. In some embodiments, one or more reaction cartridges and one or more of the reagent reservoirs are subject to temperature control.

In some embodiments, the macromolecules (e.g., peptides or polypeptides) are immobilized, directly or indirectly via a linker, on a solid support 22 (solid or porous substrate, or support matrix) disposed within an interior chamber of the reaction cartridge 1. In some embodiments, the solid support matrix 22 comprises beads or particles with the average diameter between 3 and 200 μm. In some preferred embodiments, the solid support matrix 22 is composed of a porous or gel polymer such as agarose, cellulose, silica, zeolites, montmorillonite, or clay.

In some embodiments, the solid support matrix 22 is retained within the reaction cartridge 1 by a screen, frit, membrane, filter or another filter means placed at the bottom and/or top of the cartridge. In some embodiments, the filter means material has a pore size that is smaller than the size of solid support, preferably 0.5 to 10 μm in diameter. In some preferred embodiments, the reaction cartridge comprises a filter means 24 for retaining the sample while allowing flow-through of other materials (e.g. fluids or buffers). In some embodiments, the reaction cartridge comprises one or more filter means 24 disposed within the interior chamber of the reaction cartridge, or near the fluidic input 4 or the fluidic output 5, and configured to prevent the solid support matrix 22 from leaving the cartridge 1. The filter means 24 can be composed of plastics, glass, ceramic, metal, cellulose or other fibers (both natural and man-made). Alternatively, the solid support matrix 22 can also be retained within the reaction cartridge by physical or covalent attachment of the support to the reaction cartridge 1.

In one particular embodiment, an exemplary process 200 is performed inside the reaction cartridge (FIG. 7). In some embodiments, a biological sample to be analyzed comprises polypeptides prepared for analysis prior to step 201, e.g. by means of joining polypeptides to a solid support, joining polypeptides to a nucleic acid (e.g. a recording tag), digested or fragmented polypeptides, and/or treating the polypeptides with an enzyme or a chemical agent. In some embodiments, the reaction cartridge 1 with a sample containing polypeptides is loaded by user into the reaction system 50 using a cartridge carrier 14. In some embodiments, polypeptides from a biological sample are covalently attached to the solid support matrix 22 located inside the reaction cartridge 1. In some embodiments, polypeptides are adherent, or affixed, or adsorbed, or absorbed or otherwise attached to the beads, including covalent attachment, inside the reaction cartridge. In some embodiments, once the sample comprising polypeptides is provided in the reaction cartridge, the process 200 moves to establish first and second seals in 202 between the reaction cartridge 1 and the rest of the reaction system 50 (see FIG. 6A-FIG. 6C illustrating exemplary sealing process). In particular, leak-proof fluidic connections (first seal and second seal) are established between the fluidic input 4 of the cartridge 1 and the fluid introduction channel 8 of the reaction system 50, and between the fluidic output of the cartridge 5 and the fluid receiving channel 9 of the reaction system 50. Next, the process 200 moves to prime or flush the system and fluidic connections in 203, by filling the lines with a buffer for example. In some embodiments, one or more lines of the instrument can be flushed with a gas to clear the lines and/or to remove reagents from the line. In some examples, the one or more lines is flushed with air, argon, or nitrogen. One or more steps of priming the supply line of the instrument may also be performed, such as by priming the supply line with a reagent. The system then proceeds to step 204 to set the temperature inside the reaction cartridge and deliver a wash solution to the sample. A loop is performed comprising processes 205-207 repeated n number of times followed by a process 208. During any steps prior to 209, which requires removal of reagents or a wash, the reaction cartridge can be evacuated such that solution is removed while the sample containing the polypeptides (e.g. joined to a solid support) is retained in the reaction cartridge. The sample can be removed from the reaction cartridge using any appropriate means at 209. In some embodiments, prior to or after removal of the sample from the reaction cartridge 1, the sample is prepared for sequencing and analysis. In some embodiments, the instrument further comprises a means for collecting the sample or a portion thereof released from the reaction cartridge. For example, the collection means may comprise a connection and a container for collecting the sample or a portion thereof. In some cases, the instrument is configured to allow a collection container to be connected, directly or indirectly, to the reaction cartridge. In some examples, the reaction cartridge is connected via tubing and an additional valve to a collection container. The sample collection or recovery can be an automated process. In some embodiments, the collection means can feed downstream analytical platforms or methodologies (e.g., next generation sequencing platform) with the sample recovered from the reaction cartridge.

In some embodiments, the reaction cartridge 1 comprises a removable cap 13 that covers the interior chamber of the reaction cartridge and is configured to allow loading or removal of the solid support matrix 22 (with or without an immobilized sample 23) to the interior chamber of the reaction cartridge 1. In some embodiments, the removable cap 13 is configured to establish a third seal between the cap 13 and the interior chamber of the reaction cartridge 1, for example, via screw threads. In some embodiments, the removable cap 13 comprises the fluidic input 4. In some embodiments, the removable cap 13 further comprises a first filter means configured to prevent the solid support matrix 22 from leaving the reaction cartridge from the fluidic input 4 (see FIG. 4B), whereas a second filter means 24 configured to prevent the solid support matrix 22 from leaving the reaction cartridge from the fluidic output 9 is located inside the interior chamber of the reaction cartridge 1. In some embodiments, the removable cap 13 further comprises an O-ring to ensure a first seal between the fluidic input 4 and the fluid introduction channel 8 is established. The presence of the removable cap 13 in the reaction cartridge 1 allows the cartridge to be separated and loaded with a solid support 22 (or another solid reagent), or to be opened to remove the solid support 22 after the assay is performed.

In some embodiments, the reaction cartridge 1 and the reaction system 50 use a system design where a gas is delivered via the reagent supply line and pushed through to a waste container. For example, the reaction cartridge 1 is not vented or the vent is closed and the gas is delivered to the reaction cartridge and evacuated through an outlet to a waste container. In some embodiments, flushing the supply line with a gas and/or delivering a gas to the reaction cartridge 1 may be desirable to substantially or fully remove or flush any leftover solvents, buffers and/or reagents.

In some embodiments, the reaction system 50 is configured to prevent the trapping of air inside the reaction cartridge 1. It allows delivery of a gas (a multi-phase reagent exchange) to displace a liquid reagent from the reaction cartridge and the solid support matrix 22. Once the cartridge is fully evacuated of the liquid reagent, the following liquid reagent can be delivered, fully evacuating the gas from the cartridge and replacing it with another liquid reagent, resulting in significantly (many orders of magnitude) more efficient reagent exchange. Further, it also allows a gas buffer to be placed between liquid reagents in the fluidic input and output streams to prevent diffusion of one reagent into another. Diffusion of reagents into one another could reduce reaction efficiency or assay performance.

In some embodiments, interior geometry of the reaction cartridge 1 is designed not to trap air bubbles inside the reaction cartridge 1. For example, interior geometry and fluidic interfaces of the reaction cartridge 1 can be designed so that bubbles cannot become trapped against downward-facing surfaces, and the interior geometry is designed not to have any surfaces which face downward at an angle of greater than 45 degrees from the horizon that are large enough to trap any bubbles, for example larger than 0.060 inches.

In some embodiments, the reaction system 50 comprises a porous means or a porous membrane to allow a fluid to pass through and evacuate the reaction cartridge, and to maintain a sample immobilized on a solid support 22 in the reaction cartridge 1. In preferred embodiments, the reaction system 50 comprises at least one filter means 24 configured to prevent the solid support matrix 22 from leaving the reaction cartridge 1 through either the fluidic input 4 or the fluidic output 5. The filter means 24 may be located inside the interior chamber of the reaction cartridge, or outside the interior chamber, but near the fluidic input and/or the fluidic output of the reaction cartridge. In some embodiments, the system comprises at least a first filter means and a second filter means configured to prevent the solid support matrix 22 from leaving the reaction cartridge 1 from the fluidic input 4 and the fluidic output 5, respectively. In various embodiments, filter means 24 may include, without limitation, a frit, a membrane, a mesh, a microfeature, or any other retaining element configured to retaining the sample immobilized on a solid support 22 within the interior chamber of the reaction cartridge 1, while allowing flow-through of other materials (e.g. buffers, solvents, reagents).

In some embodiments, the porous means or porous membrane is for retaining the sample from evacuating through the outlet of the reaction cartridge 1. Meanwhile, reagents and buffers may flow through the reaction cartridge and evacuate the reaction cartridge through the outlet of the reaction cartridge. Many suitable porous material can be used as the filter means. Suitable filter means may be designed to include desired characteristics including diameter, pore size, and thickness of the material. In preferred embodiments, the filter means comprises a non-reactive material. In preferred embodiments, the filter means comprises a material that does not bind to the components of the macromolecule analysis assay. In some embodiments, the filter means is made of a hydrophobic material. In other embodiments, the filter means is made of a hydrophilic material. In some embodiments, the filter means is made of a material that comprises polyethylene (PE), polytetrafluorethylene (PTFE), or a similar hydrophobic material.

In some embodiments, the filter means 24 is configured and positioned to fit inside the cartridge. In some examples, the filter means (e.g., frit or membrane) has a pore size from about 1 μm to about 500 μm. In some examples, the filter means has a pore size of less than about 50 μm, less than about 40 μm, less than about 30 μm, less than about 20 μm, less than about 10 μm, less than about 5 μm, less than about 4 μm, less than about 3 μm, less than about 2 μm, or less than about 1 μm. In some specific examples, the filter means has a pore size from about 1 μm to about 5 μm. The filter means can be of any suitable thickness and can be adjusted based on various factors including the material used and the filtering effects desired. In some examples, the filter means has a thickness of about 0.1 mm to about 5 mm, about 0.1 mm to about 1 mm, about 0.1 mm to about 0.5 mm, about 0.2 mm to about 5 mm, about 0.2 mm to about 1 mm, about 0.2 mm to about 0.5 mm. In some instances, the filter means 24 has a thickness of about 0.5 mm. In some embodiments, the reaction cartridge contains, or is loaded or prepared with support. For example, the reaction cartridge may be loaded with support (e.g. beads) that are configured for capturing polypeptides with associated and/or attached nucleic acid recording tags.

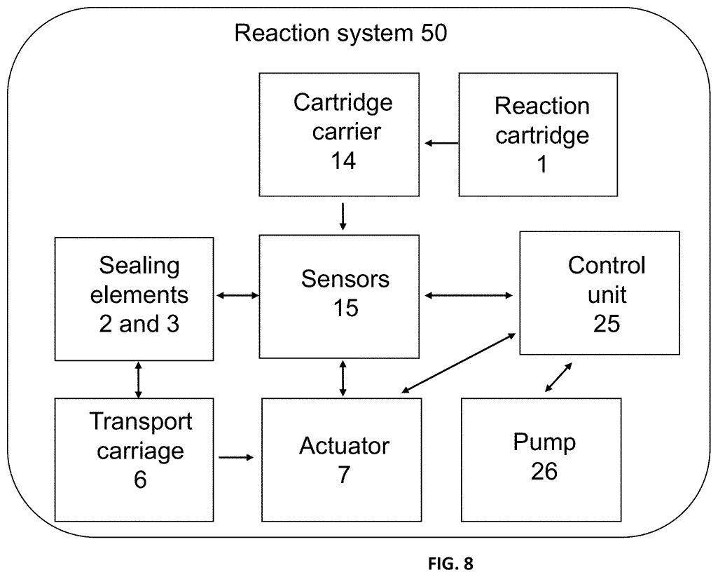

In some embodiments, one or more aspects of the system 50 is controlled by a control unit 25. In some cases, the control unit 25 also receives feedback from various components of the system 50 as depicted in FIG. 8. FIG. 8 shows a diagram representing exemplary interactions of control unit 25 with other elements of the reaction system. Control unit 25 receives feedback from positions of sealing elements 2 and 3, transport carriage 6, and optionally cartridge carrier 14 by receiving signals from sensors 15. Control unit 25 controls actuator 7, which after activation can change positions of sealing elements and transport carriage. Control unit 25 also controls flow of fluids inside and/or outside the reaction cartridge through pump 26. In some embodiments, the control unit is configured for controlling the actuator 7 and the pump 26 such that the fluid is not moved through the reaction cartridge unless the first and second seals are established. Control unit 25 also controls temperature of the reaction cartridge 1.

In some embodiments, the control unit is used to automate and/or control the temperature of the reaction cartridge 1 and/or control the temperature of the reagent reservoir(s). In some embodiments, the control unit 25 is used to automate and/or control the flow of fluids inside and/or outside the reaction cartridge (e.g., presence and absence of flow, direction of flow and/or flowrate, etc.). In some embodiments, the control unit is configured for controlling the actuator and the pump such that the fluid is not moved through the reaction cartridge unless the first and second seals are established. In some examples, a control unit is used to carry out one or more steps of a process as depicted in FIG. 7. In some embodiments, the control unit is in communication with one or more valves, one or more pumps, temperature controlled unit(s), and/or one or more reaction cartridges. In some embodiments, the control unit is used to automate and/or control positions of sealing elements 2 and 3, as well as cartridge carrier 14 inside the system during insertion of reaction cartridge 1 into the system 50 and during establishing leak-proof fluidic connections (first seal and second seal).

In some embodiments, progress of the reaction inside the reaction cartridge can be monitored using absorbance, fluorescence, refractive index or conductance.

In some embodiments, the reaction cartridge is temperature controlled. In some embodiments, temperature control is between 4 and 95° C., e.g. the reaction cartridge is subjected to both active or passive heating and cooling. Heating can be accomplished using electromagnetic radiation, and/or resistive, thermoelectric or microwave methods. Cooling can be accomplished using the thermoelectric, liquid or air cooling. The temperature can be controlled using a proportional-integral-derivative controller or other control system.

### Exemplary Embodiments

Among the provided enumerated embodiments are:
1. A reaction system comprising:
   a. a reaction cartridge comprising a fluidic input and a fluidic output;
   b. a fluid introduction channel configured to provide a fluid to the fluidic input;
   c. a first sealing element that comprises the fluid introduction channel and is configured to establish a first seal between the fluidic input and the fluid introduction channel;
   d. a fluid receiving channel configured to receive the fluid from the fluidic output;
   e. a second sealing element that comprises the fluid receiving channel and is configured to establish a second seal between the fluidic output and the fluid receiving channel; and
   f. a transport carriage configured to move the first sealing element and the second sealing element relative to the reaction cartridge such that to establish the first seal and the second seal, wherein the movement of the first sealing element and the second sealing element is achieved by using a single actuator.
2. The system of 1, further comprising a cartridge carrier configured to transport the reaction cartridge within the reaction system.
3. The system of any one of the embodiments 1-2, further comprising one or more sensors configured to detect a position of the first sealing element or the second sealing element relative to the reaction cartridge.
4. The system of any one of the embodiments 1-3, further comprising a fluid pump configured to move fluid through the reaction cartridge via the fluidic input.
5. The system of embodiment 4, further comprising control unit configured for controlling the actuator and the pump such that the fluid is not moved through the reaction cartridge unless the first and second seals are established.
6. The system of any one of the embodiments 1-5, wherein the fluidic input and the fluidic output are disposed on different sides of the reaction cartridge.
7. The system of any one of the embodiments 1-6, further comprising a solid support matrix disposed within an interior chamber of the reaction cartridge; and a reaction reagent attached to the solid support.
8. The system of embodiment 7, further comprising one or more filter means configured to prevent the solid support matrix from leaving the reaction cartridge through the fluidic input or the fluidic output.
9. The system of any one of the embodiments 7-8, wherein the system comprises at least a first filter means and a second filter means configured to prevent the solid support matrix from leaving the reaction cartridge from the fluidic input and the fluidic output, respectively.
10. The system of embodiment 9, further comprising a fluid pump configured to move fluid through the reaction cartridge from the fluidic input to the fluidic output, or in the reverse direction.
11. The system of any one of the embodiments 7-10, wherein the reaction cartridge comprises a removable cap for the interior chamber of the reaction cartridge configured to allow loading or removal of the solid support matrix to the interior chamber of the reaction cartridge.
12. The system of any one of the embodiments 1-11, wherein the system is configured such that the first seal and the second seal are established at different times.
13. The system of any one of the embodiments 7-12, wherein the reaction reagent is a polypeptide and wherein the reaction cartridge further comprises a second reagent that is not attached to the solid support matrix and configured to bind to the polypeptide.
14. The system of any one of the embodiments 1-13, wherein the transport carriage is configured to establish the first and second seals only when the reaction cartridge is held in place.
15. A method of reacting a first reagent and a second reagent in a reaction cartridge, the method comprising:
   a. placing the reaction cartridge in a reaction system between a first sealing element and a second sealing element of the reaction system, wherein the reaction cartridge comprises a fluidic input and a fluidic output, and further comprises within an interior chamber the first reagent attached to a solid support matrix; and wherein the reaction system further comprises: (i) a fluid introduction channel located within the first sealing element and configured to provide a fluid to the fluidic input; (ii) a fluid receiving channel located within the second sealing element and configured to receive the fluid from the fluidic output; and (iii) a transport carriage configured to move the first sealing element and the second sealing element relative to the reaction cartridge so that to establish a first seal between the fluidic input and the fluid introduction channel, and to establish a second seal between the fluidic output and the fluid receiving channel, wherein the movement is achieved by using a single actuator;
   b. activating the single actuator so that to establish the first seal and the second seal; and
   c. introducing the second reagent to the reaction cartridge via the fluidic input by pumping a fluid comprising the second reagent, thereby reacting the first reagent and the second reagent.
16. The method of embodiment 15, further comprising transporting the reaction cartridge to a position between the first and the second sealing elements by a cartridge carrier, wherein the reaction cartridge is held in place by the cartridge carrier during establishment of the first and second seals.
17. The method of any one of the embodiments 15-16, further comprising detecting that the first and second seals are established using feedback from a pressure sensor or from a motor current of the actuator.
18. The method of any one of the embodiments 15-17, further comprising breaking the first seal and the second seal, wherein the single actuator is used to break the first seal and the second seal.
19. The method of any one of the embodiments 15-19, wherein the first reagent is a polypeptide and the second reagent is configured to bind to the polypeptide.
20. The method of embodiment 19, further comprising recovering a product generated after reacting the first reagent and the second reagent from the reaction cartridge and subjecting the product to a next generation nucleic acid sequencing procedure.
21. The method of any one of the embodiments 15-20, wherein the system is configured such that the first seal and the second seal are established at different times.
22. The method of any one of the embodiments 15-21, wherein the system comprises at least a first filter means and a second filter means configured to prevent the solid support matrix from leaving the reaction cartridge from the fluidic input and the fluidic output, respectively.
23. The method of any one of the embodiments 15-22, wherein the system is as described in one of the embodiments 1-14.

### EXAMPLES

The following examples are offered to illustrate but not to limit the methods, systems, and uses provided herein. Certain aspects of the present invention, including, but not limited to, embodiments for the Proteocode™ peptide sequencing assay, information transfer between coding tags and recording tags, methods of making nucleotide-peptide conjugates, methods for attachment of nucleotide-peptide conjugates to a support, methods of generating barcodes, methods of generating specific binding agents recognizing an N-terminal amino acid of a peptide, reagents and methods for modifying and/or removing an N-terminal amino acid from a peptide, methods for analyzing extended recording tags were disclosed in the earlier published application US 2019/0145982 A1, US 2020/0348308 A1, US 2020/0348307 A1, US 2021/0208150 A1, US 2021/0214701 A1, US 2022/0049246 A1, the contents of which are incorporated herein by reference in its entirety.

### Example 1. Exemplary Description of the Sealing Process

Before inserting the reaction cartridge 1 to be sealed, the system 50 must be at its widest spread, as illustrated in FIG. 3A, and wherein the upper and lower photo interrupter optical sensors 15 indicate the sealing elements 2 and 3 are at their maximum distance apart. The reaction cartridge 1 is inserted into the cartridge carrier 14, and the reaction cartridge-carrier assembly is inserted into a cartridge loader system. The reaction cartridge-carrier assembly is inserted until it is stopped by the rear wall of the cartridge loader system and feedback for correct insertion is indicated both tactilely, with a click of a spring-loaded ball nose plunger and electronically with the reaction cartridge-carrier assembly interacting with a photo interrupter optical sensor 15, giving indication to a user by turning on a lamp, such as an LED. The reaction cartridge-carrier assembly is guided during insertion by the cartridge carrier fork. The reaction cartridge-carrier assembly is held against the heater-cooler block, which serves as a system datum, by the spring-like cartridge carrier biaser, and held down against the heater-cooler block by the spring-like cartridge carrier fork. The reaction cartridge 1 is now ready to be fluidically sealed. If the cartridge carrier photo interrupter optical sensor 15 is not sensing full cartridge carrier insertion, then the control system will prevent fluidic engagement. The stepper motor of the actuator 7 is energized using the control system and begins to turn the lead screw 17 in a clockwise direction, in one example, the NEMA8 motor with non-captive lead screw will require over 4200 steps to move the lead screw 17 by one millimeter. The sealing element 2 will move first to engage the fluidic input 4 of the reaction cartridge. The fluidic input 4 will typically move first due to lesser friction and gravity. Once the fluidic input 4 of the reaction cartridge starts to become engaged, friction will increase and overcome the effect of friction and gravity preventing the sealing element 3 from movement. The sealing element 3 will then start to move and final sealing is obtained after a sufficient total movement of the described components has been achieved and the O-ring components of the seals in the reaction cartridge are compressed by a sufficient amount, typically 10-30% compression. Establishment of the first and second seals can be determined by measuring pressure during deliveries of air or fluid with the exit side blocked.

### Example 2. Assessment of Cartridge Sealing Using Deliveries of Air and Detecting Pressure Buildup Using the Pressure Sensor

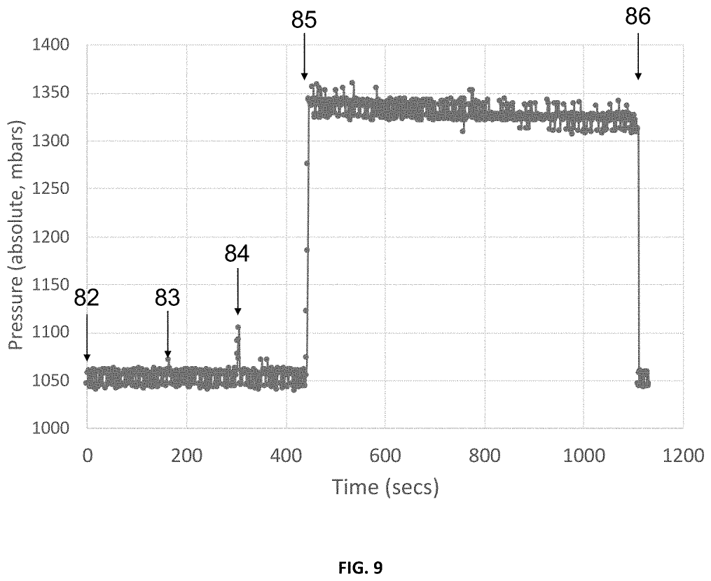

For this experiment, a syringe pump was connected to the sealing element 2 with the appropriate fittings and tubing (ID=0.020″, TEFZEL™, all available from IDEX) with the pressure sensor (IDEX I2C-PS200) measuring pressure between the syringe pump and a cartridge loader system. The sealing element 3 also had appropriate fittings and tubing except that the exit line fitting was plugged by connecting a union (IDEX Part P-620) with a plug fitting (IDEX Part P-311) instead of having the exit line go to a waste container. The cartridge 1 was inserted into the cartridge loader system until the rear photosensor 15 detected full and correct insertion. For each measurement, 200 μL of air was aspirated and then delivered to the cartridge loader system at 50 μL/s and pressure data was collected at 1 second intervals. Before each movement, the cartridge loader system was homed by detecting when the upper photosensor 15 was interrupted by a flag attached to the sealing element 2. In this case, “home” was set at 0.00 mm. The linear actuator 7 was then moved different amounts, expressed as the total distance the lead screw 17 turned and then air was then injected into fluidic system. Pressure readings were made every 1 sec and recorded. At the end of measurement, and before the next measurement, pressure was released from the system by undoing the exit line plug and then resealing it before the next measurement. The results of the described sealing test after moving different total distances are shown in FIG. 9. Numbers above arrows indicate the following time points: 82—pressure after moving a distance of 8.2 mm; 83—pressure after moving 8.3 mm; 84—pressure after moving 8.4 mm; 85—pressure after moving 8.5 mm; 86—pressure after removing the exit line plug.

### Example 3. Identifying an N-Terminal Amino Acid of a Polypeptide Via a Single Cycle Encoding Performed on an Automated Instrument 60 with the Cartridge Loader System

This experiment describes treatment of polypeptides for a ProteoCode™ assay in the cartridge 1 performed using an exemplary instrument 60. The experiment included the following steps: binding/encoding→end-capping. Programmed automated processes for binding and performing the endcap reaction were carried out by a control unit connected to the instrument 60. Among other features described in the processes below, the instrument 60 used for this experiment has a 6-way rotary valve and a syringe pump with a 6-way rotary valve. The pump valve uses three positions for reagent input, reaction cartridge output and a waste bypass, the other ports on the syringe valve can be used for reagents. The instrument used can be loaded with up to 12 reagents and the reaction cartridge 1 that are subjected to active heating and cooling.

Sample Loading and Pre-Washing

100 μL of peptides labelled with a DNA recording tag immobilized on a solid support matrix was added to the reaction cartridge 1. Each sample loaded into the cartridge contained 50,000 beads, and peptides labelled with a DNA recording tag were loaded on porous beads at a controlled density of one activated functional moiety for attaching the peptide-recording tag chimera per 100,000 passivated (blocked) molecules (1:100K). Each reaction cartridge contained a PTFE frit (5.1 mm diameter, 3 mm thickness, and 3 μm pore size) such that the sample containing polypeptides immobilized on beads was retained in the cartridge, and fluids, wash solutions, and reagents delivered to the cartridge can be removed by positive pressure applied to the cartridge. A pump and valve(s) integrated on the instrument were used to control dispensing and flow of the reagents on the system and delivery of reagents to the sample in the cartridges. Flow-through removed from the cartridges were dispensed into a waste container. The reaction cartridge 1 was loaded with peptides immobilized on a solid support matrix (porous beads) and then the cap 13 of the reaction cartridge 1 was closed and sealed using an adhesive such as Dowsil™. The reaction cartridge 1 was inserted into the cartridge carrier 14, which was then inserted into the cartridge loader system as described in Example 1. The sealing elements 2 and 3 were used to establish the first and second seals as described in Example 1.

Exemplary peptides tested in the assay included peptides with an N-terminal amino acid residues FS (FS-peptide, FSGVAMPGAEDDVVGSGSK, as set forth in SEQ ID NO: 1); peptides with a F residue in the penultimate position (AFSGVAMPGAEDDVVGSGSK set forth in SEQ ID NO: 2), with a F residue in the third position (AEFSGVAMPGAEDDVVGSGSK set forth in SEQ ID NO: 3), with a F residue in the 4^{th} position (AEAFSGVAMPGAEDDVVGSGSK set forth in SEQ ID NO: 4), with a F residue in the fifth position (AESAFSGVAMPGAEDDVVGSGSK(azide)-OH set forth in SEQ ID NO: 5), and with a F residue in the 10^{th} position (AESAESAESFSGVAMPGAEDDVVGSGSK(azide)-OH, set forth in SEQ ID NO: 6).

Prior to initiating the binding and encoding process, the beads were pre-washed in the cartridge with 500 μL of PBST (4 mM sodium phosphate, 155 mM sodium chloride (NaCl), and 0.1% Tween 20).

One Cycle of Binding and Encoding

Binding/encoding was performed in the cartridge 1 as follows using exemplary programmed automated binding and encoding processes. Before each delivery, the common fluidic lines and pump were rinsed and pre-equilibrated with a new reagent in order to ensure the delivery of reagent to the reaction cartridge had as little cross-contamination as possible. This pre-equilibration was accomplished by one or more aspirations of a reagent and then dispensing to waste, bypassing the reaction cartridge. The thermal-block was set to 25° C. (+/−1° C.). Once the set temperature is reached, 200 μL of an exemplary binding agent that binds phenylalanine when it is the N-terminal amino acid residue (F-binder) were delivered to the beads in the cartridge and incubated for 15 minutes. The binding agents were conjugated with a coding tag oligo containing information regarding the binding agent. After the binding agent bound its corresponding target (an N-terminal amino acid residue F), the 3′-spacer′ region of the coding tag hybridized to the 3′-spacer of the recording tag oligo linked with the peptide. After 15 minutes of incubation, the beads were washed with 500 μL of Binder Wash Buffer (BWH, 4 mM sodium phosphate, 500 mM sodium chloride, 0.1% Tween 20). For transfer of information from the coding tag to the recording tag, a total of 500 μL of Encoding Master Mix (EMM, 50 mM Tris-HCl pH 7.5, 2 mM MgSO₄, 50 mM NaCl, 1 mM DTT, 0.1% Tween 20, 100 μg/mL BSA, 0.125 mM dNTPs, 0.125 U/μL Klenow fragment (3′->5′ exo-) (MCLAB, USA)) was delivered to the beads and incubated for 5 minutes at 25° C. If the binding agent bound its target, the recording tag associated with the polypeptide was elongated by copying the coding tag by extension and information was transferred from the coding tag associated with the F binding agent (F-binder) to the recording tag linked to the peptide (thereby forming an extended recording tag). After the 5 minute incubation, the beads were washed with 500 μL of Strand Displacing Mix (SHT, 0.1 M sodium hydroxide with 0.1% Tween 20), followed by 2× washes of 500 μL of PBST.

End-Capping

The following describes the end-capping process performed in the cartridge using an exemplary automated programmed process for end-capping. 500 μL of an End-Capping solution (CAP, 400 nM capping oligo, 50 mM Tris-HCl pH 7.5, 2 mM MgSO4, 50 mM NaCl, 1 mM DTT, 0.1% Tween 20, 100 μg/mL BSA, 0.125 mM dNTPs, 0.125 U/μL Klenow exo-) were delivered to the beads. The capping oligo provided in this step contained a universal priming sequence which is added to the recording tag using an extension reaction to generate a final product for NGS readout. The beads were incubated in the end-capping solution for 10 minutes at 25° C. and washed with 500 μL of SHT, followed by 1000 μL of SHT. Following the end-capping reaction, the cartridges were removed from the instrument and the sample (e.g., polypeptides immobilized on beads with the extended recording tags) was removed from the cartridge by breaking opening the cap 13 of the cartridge and recovering the beads from the interior chamber of the cartridge.

Sample Processing and Analysis

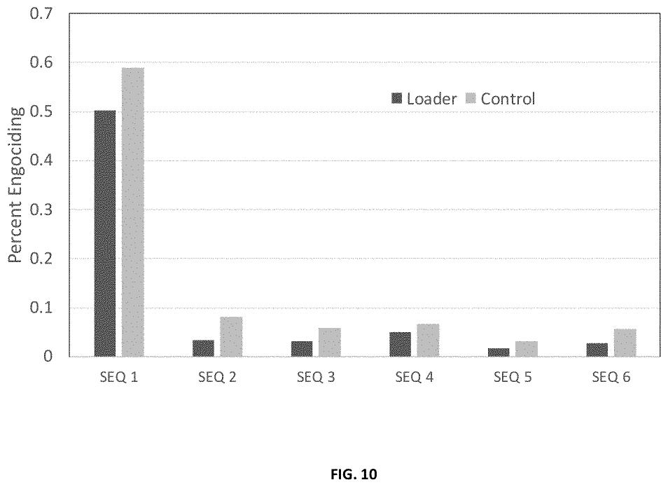

The extended recording tag of the assay was subjected to PCR amplification and analyzed by next-generation sequencing (NGS). The NGS results indicated that the sample treated in the cartridge (FIG. 10) showed cycle-specific encoding of the F-peptide (SEQ 1, SEQ ID NO: 1) at cycle 1, but very little cycle specific encoding for the other peptides in the mix (SEQ 2-SEQ 6, SEQ ID NO: 1-SEQ ID NO: 6, respectively). The F-binder detected the N-terminal phenylalanine (F) in the FS-peptide in the 1st cycle. The control reactions shown in FIG. 10 were manually treated reactions (without use of the exemplary cartridge 1 and reaction system 50) and showed a similar encoding profile, albeit with slightly higher encoding of the non-F terminal peptides (SEQ 2-6). The data shown in FIG. 10 are the average of two encoding results for the two independent automated reactions, and the average of four results for the manual reactions (control). In summary, the treatment of the polypeptides using the exemplary cartridge 1 and reaction system 50 resulted in successful treatment and processing of polypeptides and formation of extended recording tags containing polypeptide information that can be used to identify amino acid sequences of the treated polypeptides.

The present disclosure is not intended to be limited in scope to the particular disclosed embodiments, which are provided, for example, to illustrate various aspects of the invention. Various modifications to the compositions and methods described will become apparent from the description and teachings herein. Such variations may be practiced without departing from the true scope and spirit of the disclosure and are intended to fall within the scope of the present disclosure. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A reaction system comprising:
a. a reaction cartridge comprising a fluidic input and a fluidic output;
b. a fluid introduction channel configured to provide a fluid to the fluidic input;
c. a first sealing element that comprises the fluid introduction channel and is configured to establish a first seal between the fluidic input and the fluid introduction channel;
d. a fluid receiving channel configured to receive the fluid from the fluidic output;
e. a second sealing element that comprises the fluid receiving channel and is configured to establish a second seal between the fluidic output and the fluid receiving channel; and
f. a transport carriage configured to move the first sealing element and the second sealing element relative to the reaction cartridge such that to establish the first seal and the second seal, wherein the movement of the first sealing element and the second sealing element is achieved by using a single actuator.

2. The system of claim 1, further comprising a cartridge carrier configured to transport the reaction cartridge within the reaction system.

3. The system of claim 1, further comprising one or more sensors configured to detect a position of the first sealing element or the second sealing element relative to the reaction cartridge.

4. The system of claim 1, further comprising a fluid pump configured to move fluid through the reaction cartridge via the fluidic input.

5. The system of claim 4, further comprising control unit configured for controlling the actuator and the pump such that the fluid is not moved through the reaction cartridge unless the first and second seals are established.

6. The system of claim 1, wherein the fluidic input and the fluidic output are disposed on different sides of the reaction cartridge.

7. The system of claim 6, further comprising a solid support matrix disposed within an interior chamber of the reaction cartridge; and a reaction reagent attached to the solid support.

8. The system of claim 7, further comprising one or more filter means configured to prevent the solid support matrix from leaving the reaction cartridge through the fluidic input or the fluidic output.

9. The system of claim 8, wherein the system comprises at least a first filter means and a second filter means configured to prevent the solid support matrix from leaving the reaction cartridge from the fluidic input and the fluidic output, respectively.

10. The system of claim 9, further comprising a fluid pump configured to move fluid through the reaction cartridge from the fluidic input to the fluidic output, or in the reverse direction.

11. The system of claim 9, wherein the reaction cartridge comprises a removable cap for the interior chamber of the reaction cartridge configured to allow loading or removal of the solid support matrix to the interior chamber of the reaction cartridge.

12. The system of claim 1, wherein the system is configured such that the first seal and the second seal are established at different times.

13. The system of claim 7, wherein the reaction reagent is a polypeptide and wherein the reaction cartridge further comprises a second reagent that is not attached to the solid support matrix and configured to bind to the polypeptide.

14. The system of claim 1, wherein the transport carriage is configured to establish the first and second seals only when the reaction cartridge is held in place.

15. A method of reacting a first reagent and a second reagent in a reaction cartridge, the method comprising:
a. placing the reaction cartridge in a reaction system between a first sealing element and a second sealing element of the reaction system, wherein the reaction cartridge comprises a fluidic input and a fluidic output, and further comprises within an interior chamber the first reagent attached to a solid support matrix; and wherein the reaction system further comprises: (i) a fluid introduction channel located within the first sealing element and configured to provide a fluid to the fluidic input; (ii) a fluid receiving channel located within the second sealing element and configured to receive the fluid from the fluidic output; and (iii) a transport carriage configured to move the first sealing element and the second sealing element relative to the reaction cartridge so that to establish a first seal between the fluidic input and the fluid introduction channel, and to establish a second seal between the fluidic output and the fluid receiving channel, wherein the movement is achieved by using a single actuator;
b. activating the single actuator so that to establish the first seal and the second seal; and
c. introducing the second reagent to the reaction cartridge via the fluidic input by pumping a fluid comprising the second reagent, thereby reacting the first reagent and the second reagent.

16. The method of claim 15, further comprising transporting the reaction cartridge to a position between the first and the second sealing elements by a cartridge carrier, wherein the reaction cartridge is held in place by the cartridge carrier during establishment of the first and second seals.

17. The method of claim 15, further comprising detecting that the first and second seals are established using feedback from a pressure sensor or from a motor current of the actuator.

18. The method of claim 15, further comprising breaking the first seal and the second seal, wherein the single actuator is used to break the first seal and the second seal.

19. The method of claim 15, wherein the first reagent is a polypeptide and the second reagent is configured to bind to the polypeptide.

20. The method of claim 19, further comprising recovering a product generated after reacting the first reagent and the second reagent from the reaction cartridge and subjecting the product to a next generation nucleic acid sequencing procedure.
